(19) United States
(12) Patent Application Publication
(10) Pub. No.: US 2008/0043334 A1
(43) Pub. Date: Feb. 21, 2008

(54) Diffractive optical relay and method for manufacturing the same

(75) Inventors: Moti Itzkovitch, Petach-Tikva (IL); Tal Cohen, Herzlia (IL)

Correspondence Address: Martin D. Moynihan;PRTSI, Inc., P.O. Box 16446, Arlington, VA, 22215, US

(73) Assignee: Mirage Innovations Ltd., Rechovot (IL)

(21) Appl. No.: 11/505,866

(22) Filed: Aug. 18, 2006

(51) Int. Cl. G02B 5/18

(52) U.S. Cl. 359/569; 359/566

(57) ABSTRACT

An optical relay device, comprising a substrate, and at least one diffractive optical element is disclosed. The substrate is made, at least in part, of a light transmissive polymeric material characterized by a birefringence, Δn, satisfying the inequality |Δn|<ε, where ε is lower than the birefringence of polycarbonate. In a preferred embodiment, the light transmissive polymeric material comprises a cycloolefin polymer or a cycloolefin copolymer.

### FIELD AND BACKGROUND OF THE INVENTION

The present invention relates to planar optics and, more particularly, to a diffractive optical relay having improved optical properties, and a method for manufacturing the diffractive optical relay.

Recent advances in the area of optics have enabled progress in planar optical devices capable of guiding light for the purpose of providing illumination or for the purpose of transmission of various types of optical signals, such as images or digital information. The flexibility to manipulate optical signals provided by the planar optical geometry is higher than that achievable in a one-dimensional waveguide. Planar optical devices are currently used in a large number of applications, including image display systems, digital communication systems, optical switches, spectral analyzers and the like.

Many planar optical devices employ one or more diffractive optical elements, which utilizes light diffraction phenomenon to realize various optical functions, including, inter alia, converging, diverging, filtering and/or converting the intensity distribution of light. most diffractive optical elements are provided in a form of a diffraction grating. diffraction gratings are patterns of periodic structures, which are typically in the form of surface grooves. Also known are volume gratings in which a periodic variation of the index of refraction is recorded in few microns to few tens of microns material. Diffraction gratings for visible light typically contain from a few hundreds to a few thousands grooves, with a distance of the order of one micrometer or less between adjacent grooves. Diffraction gratings are broadly categorized into ruled diffraction gratings and holographic diffraction gratings. Ruled diffraction gratings are produced by physically forming grooves into a substrate, while holographic diffraction gratings are produced by recording a standing wave pattern of an interference fringe field formed by coherent light beams on a photosensitive layer.

In the area of image displays, diffractive optical elements have been employed to provide virtual images. U.S. Pat. No. 4,711,512 to Upatnieks, for example, discloses a head-up display based on planar optics technique, by the use of relatively thick volume holograms. Collimated light wavefronts of an image enter a glass plate, located in an aircraft cockpit between the pilot and the aircraft windscreen, through an input diffraction grating element, are transmitted through the glass plate by total internal reflection and are coupled out in a direction of an eye of a pilot, by means of another diffractive element.

U.S. Pat. No. 5,966,223 to Friesem et. al. discloses a holographic optical device similar to that of Upatnieks, with the additional aspect that the first diffractive optical element acts further as the collimating element that collimates the waves emitted by each data point in a display source and corrects for field aberrations over the entire field-of-view.

U.S. Pat. No. 6,757,105 to Niv et al., the contents of which are hereby incorporated by reference, provides optical relay for optimizing a field-of-view for a multicolor spectrum. The optical relay includes a light-transmissive substrate and a linear grating formed therein. Niv et al. teach how to select the pitch of the linear grating and the refraction index of the light-transmissive substrate so as to trap a light beam having a predetermined spectrum and characterized by a predetermined field of view to propagate within the light-transmissive substrate via total internal reflection. Niv et al. also disclose an optical device incorporating the optical relay for transmitting light in general and images in particular into the eye of the user.

A binocular device which employs several diffractive optical elements is disclosed in U.S. patent application Ser. No. 10/896,865 and in International Patent Application, Publication No. WO 2006/008734, the contents of which are hereby incorporated by reference. An optical relay is formed of a light transmissive substrate, an input diffractive optical element and two output diffractive optical elements. Collimated light is diffracted into the optical relay by the input diffractive optical element, propagates in the substrate via total internal reflection and coupled out of the optical relay by two output diffractive optical elements. The input and output diffractive optical elements preserve relative angles of the light rays to allow transmission of images with minimal or no distortions. The output elements are spaced apart such that light diffracted by one element is directed to one eye of the viewer and light diffracted by the other element is directed to the other eye of the viewer.

Holographic diffraction gratings for the above applications are manufactured via photolithography and etching which allow to process a fine three-dimensional structure with a high precision. A standing wave pattern, usually obtained by interference between two monochromatic coherent laser beams, is recorded on a photoresist material deposited on a work substrate. The photoresist is subsequently developed and the work substrate is subjected to a selective etching, to form a surface relief pattern corresponding to the standing wave pattern or a negative thereof, depending on the type of the photoresist. Typically, the thus formed surface relief is used as a master holographic grating which is coated and replicated by a various methods such as injection molding, pressure molding, vacuum deposition, chemical deposition and the like.

In conventional planar optical devices the diffraction gratings are typically formed on substrates made of a light transmissive material having a high refractive index which allow reducing the overall thickness of the devices. Known in the art are diffractive optical elements formed on substrates made of polycarbonate, polystyrene, polymethyl methacrylate, silica and high refractive index glass. Mostly used are transparent materials such as polycarbonate and glass.

The optical properties of optical devices made of such materials are, however, far from being optimal. Polycarbonate, for example, although having good surface properties, suffers from poor light transmission efficiency. Glass, on the other hand, has lower transmission losses relative to polycarbonate, but its relatively high rigidness makes it a less favored material, in particular in manufacturing processes which employ injection molding or pressure molding techniques, and its higher density makes it less favored material for head worn display systems.

There is thus a widely recognized need for, and it would be highly advantageous to have a diffractive optical relay having improved optical properties, devoid of the above limitations.

### SUMMARY OF THE INVENTION

According to one aspect of the present invention there is provided an optical relay device, comprising: a substrate, made at least in part of a light transmissive polymeric material characterized by a birefringence, Δn, satisfying the inequality |Δn|<ε, wherein ε is lower than the birefringence of polycarbonate; and at least one diffractive optical element located on at least one surface of the substrate.

According to still further features in the described preferred embodiments the diffractive optical element(s) is formed on the at least one surface.

According to still further features in the described preferred embodiments the diffractive optical element(s) is attached to the at least one surface.

According to further features in preferred embodiments of the invention described below, the at least one diffractive optical element comprises an input to diffractive optical element and at least one output diffractive optical element.

According to still further features in the described preferred embodiments the at least one diffractive optical element comprises a linear grating.

According to still further features in the described preferred embodiments the thickness of the substrate is sufficiently large so as to allow light having any wavelength within a predetermined spectrum and any striking angle within a predetermined range of angles, to propagate in the substrate via total internal reflection.

According to still further features in the described preferred embodiments the at least one diffractive optical element comprises an input diffractive optical element, a first output diffractive optical element and a second output diffractive optical element.

According to still further features in the described preferred embodiments the input diffractive optical element is designed and constructed for diffracting light striking the device at a plurality of angles within a predetermined field-of-view into the substrate, such that light corresponding to a first partial field-of-view propagates via total internal reflection to impinge on the first output diffractive optical element, and light corresponding to a second partial field-of-view propagates via total internal reflection to impinge on the second output diffractive optical element, the first partial field-of-view being different from the second partial field-of-view.

According to another aspect of the present invention there is provided a system for providing an image to a user, comprising an optical relay device as described herein for transmitting an image into at least one eye of the user, and an image generating system for providing the optical relay device with collimated light constituting the image.

According to further features in preferred embodiments of the invention described below, the input diffractive optical element is designed and constructed for diffracting light originated from the image into the substrate such that a first partial field-of-view of the image propagates via total internal reflection to impinge on the first output diffractive optical element, and a second partial field-of-view of the image propagates via total internal reflection to impinge on the second output diffractive optical element, the first partial field-of-view being different from the second partial field-of-view.

According to still further features in the described preferred embodiments the image generating system comprises a light source, at least one image carrier and a collimator for collimating light produced by the light source and reflected or transmitted through the at least one image carrier.

According to still further features in the described preferred embodiments the image generating system comprises at least one miniature display and a collimator for collimating light produced by the at least one miniature display.

According to still further features in the described preferred embodiments the image generating system comprises a light source, configured to produce light modulated imagery data, and a scanning device for scanning the light modulated imagery data onto the input diffractive optical element.

According to yet another aspect of the present invention there is provided a method of manufacturing an optical relay device having at least one linear grating, comprising: forming a mold having at least one pattern corresponding to an inverted shape of the at least one linear grating; and contacting the mold with a light transmissive polymeric material characterized by low birefringence, so as to provide a substrate having the at least one linear grating formed on at least one surface thereof.

According to still further features in the described preferred embodiments the polymeric material comprises a cycloolefin polymer.

According to still further features in the described preferred embodiments the polymeric material comprises a polycyclic polymer.

According to still further features in the described preferred embodiments the light transmissive polymeric material comprises a copolymer.

According to still further features in the described preferred embodiments the copolymer comprises a cycloolefin copolymer.

According to still further features in the described preferred embodiments the copolymer comprises a polycyclic copolymer.

According to still further features in the described preferred embodiments the contacting is by injection molding.

According to still further features in the described preferred embodiments the light transmissive polymeric material is in a solid form. According to still further features in the described preferred embodiments the light transmissive polymeric material is in form of a substrate having optically flat surfaces. According to still further features in the described preferred embodiments the method further comprises coating at least one of the optically flat surfaces by a curable modeling material, prior to the contacting of the mold with the light transmissive polymeric material. According to still further features in the described preferred embodiments the contacting comprises pressing the mold against the light transmissive polymeric material in the solid form.

According to still further features in the described preferred embodiments at least one surface of the mold is formed by coating a master substrate having the at least one linear grating formed thereon by a metallic layer, and separating the metallic layer from the master substrate, thereby forming the at least one surface.

According to still further features in the described preferred embodiments the mold comprises a second surface which is substantially flat.

According to still further features in the described preferred embodiments the coating of the master substrate by the metallic layer comprises sputtering followed by electroplating.

According to still further features in the described preferred embodiments the method further comprises forming the master substrate.

According to still further features in the described preferred embodiments the master substrate is formed as follows: a first substrate is coated by a layer of curable modeling material; the first substrate is contacted with a second substrate having the inverted shape of the at least one linear grating formed thereon; the curable modeling material is cured to provide a cured layer patterned according to the shape of the at least one linear grating; and the first substrate is separated from the second substrate to expose the cured layer on the first substrate.

According to still further features in the described preferred embodiments the curable modeling material comprises at least one photopolymer component, and the step of curing the curable modeling material comprises irradiating the curable modeling material by electromagnetic radiation.

According to still further features in the described preferred embodiments the curable modeling material comprises at least one curable component, and the step of curing the curable modeling material comprises irradiating the curable modeling material by curing radiation.

According to still further features in the described preferred embodiments the curable modeling material comprises a thermally settable material, and the step of curing the curable modeling material comprises applying heat to the thermally settable material.

According to still further features in the described preferred embodiments the method further comprises, prior to the step of contacting the first substrate with the second substrate, forming the inverted shape of the at least one linear grating on the second substrate.

According to still further features in the described preferred embodiments the inverted shape of the at least one linear grating is formed on the second substrate by a ruling engine.

According to still further features in the described preferred embodiments the inverted shape of the at least one linear grating is formed on the second substrate by lithography followed by etching.

According to still further features in the described preferred embodiments the lithography comprises photolithography.

According to still further features in the described preferred embodiments the lithography comprises electron beam lithography.

The present invention successfully addresses the shortcomings of the presently known configurations by providing a diffractive optical relay and a method for manufacturing the diffractive optical relay.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In case of conflict, the patent specification, including definitions, will control. In addition, the materials, methods, and examples are illustrative only and not intended to be limiting.

Implementation of the method and system of the present invention involves performing or completing selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIGS. 1A-B are schematic illustrations of side view (FIG. 1A) and a top view (FIG. 1B) of an optical relay device, according to various exemplary embodiments of the present invention;

FIGS. 2A-B are schematic illustrations of a perspective view (FIG. 2A) and a side view (FIG. 2B) of the optical relay device, in a preferred embodiment in which one input optical element and two output optical elements are employed;

FIGS. 3A-B are schematic illustrations of wavefront propagation within the optical relay device, according to various exemplary embodiments of the present invention;

FIG. 4 is a schematic illustration of a system for providing an image to a user, according to various exemplary embodiments of the present invention;

FIGS. 5A-C are fragmentary views schematically illustrating the system shown in FIG. 4, in a preferred embodiment in which spectacles are used;

FIGS. 6A-D are flowchart diagrams of method steps suitable for manufacturing the optical relay device, according to various exemplary embodiments of the present invention;

FIGS. 7A-L are schematic process illustrations describing various manufacturing steps of the optical relay device, according to various exemplary embodiments of the present invention; and

FIGS. 8A-B are graphs showing dimensionless birefringence as a function of the position across a material sample, for a polycarbonate sample (FIG. 8A) and a cycloolefin polymer sample (FIG. 8B).

### DESCRIPTION OF THE PREFERRED EMBODIMENTS

The present embodiments comprise a device and system which can be used for transmitting light. Specifically, the present embodiments can be used to diffract, propagate and transmit light, with minimal or no optical losses due to birefringence. The present embodiments further comprise a method suitable for manufacturing the device.

The principles and operation of a device and method according to the present invention may be better understood with reference to the drawings and accompanying descriptions.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

When a ray of light moving within a light-transmissive substrate and striking one of its internal surfaces at an angle α_{I} as measured from a normal to the surface, it can be either reflected from the surface or refracted out of the surface into the open air in contact with the substrate. The condition according to which the light is reflected or refracted is determined by Snell's law, which is mathematically realized through the following equation:

n_{A} sin α₂=n_{S} sin α_{I}, (EQ. 1)

where n_{S} is the index of refraction of the light-transmissive substrate, n_{A} is the index of refraction of the medium outside the light transmissive substrate (n_{S}>n_{A}), and α₂ is the angle in which the ray is refracted out, in case of refraction. Similarly to α_{I}, α₂ is measured from a normal to the surface. A typical medium outside the light transmissive substrate is air having an index of refraction of about unity.

As used herein, the term “about” refers to ±10%.

As a general rule, the index of refraction of any substrate depends on the specific wavelength λ of the light which strikes its surface. Given the impact angle, α_{I}, and the refraction indices, n_{S} and n_{A}, Equation 1 has a solution for α₂ only for α_{I} which is smaller than arcsine of n_{A}/n_{S} often called the critical angle and denoted α_{c}. Hence, for sufficiently large α_{I} (above the critical angle), no refraction angle α₂ satisfies Equation 1 and light energy is trapped within the light-transmissive substrate. In other words, the light is reflected from the internal surface as if it had stroked a mirror. Under these conditions, total internal reflection is said to take place, and the substrate serves as a waveguide material. Since different wavelengths of light (i.e., light of different colors) correspond to different indices of refraction, the condition for total internal reflection depends not only on the angle at which the light strikes the substrate, but also on the wavelength of the light. In other words, an angle which satisfies the total internal reflection condition for one wavelength may not satisfy this condition for a different wavelength.

In planar optics there is a variety of optical elements which are designed to provide an appropriate condition of total internal reflection so that light incident upon a light transmissive substrate will be transmitted within the substrate over a predetermined optical distance. Typically, such optical elements are manufactured as linear gratings which are located on one surface of a light-transmissive substrate at or opposite to the entry point of the light rays. A linear grating is characterized by a so-called grating period or grating pitch, d. A ray of light with a wavelength λ, which is incident upon such linear grating located onto a light-transmissive substrate at an angle α_{I}, is diffracted by the grating into and angle α_{D}. The relation between the grating period, the wavelength of the light, the index of refraction of the substrate and the angles of incidence and diffraction is given by the following equation:

n_{S} sin α_{D}−n_{A} sin α_{I}=±λ/d. (EQ. 2)

According the known conventions, the sign of α_{I} and α_{D} is positive, if the angles are measured clockwise from the normal to the surface, and negative otherwise. The dual sign on the RHS of Equation 2 relates to two possible orders of diffraction, +1 and −1, corresponding to diffractions in opposite directions, say, “diffraction to the right” and “diffraction to the left,” respectively.

The available range of incident angles is often referred to in the literature as a “field-of-view.” A field-of-view can be expressed either inclusively, in which case its value corresponds to the difference between the minimal and maximal incident angles, or explicitly in which case the field-of-view has a form of a mathematical range or set. Thus, for example, a field-of-view, φ, spanning from a minimal incident angle, α, to a maximal incident angle, β, is expressed inclusively as φ=β−α, and exclusively as φ=[α, β]. The minimal and maximal incident angles are also referred to as leftmost and rightmost incident angles or clockwise and counterclockwise field-of-view angles, in any combination. The inclusive and exclusive representations of the field-of-view are used herein interchangeably.

The refraction index of a given material expresses the reduction of the light's phase velocity within the material compared to the phase velocity of light in vacuum. Formally, n=c/v, where c is the phase velocity of light in vacuum and v is phase velocity of light in the material. Thus, the higher the refraction index of the material, the lower is the phase velocity of light within the material. The light's phase velocity is reduced in a material because the light is an electromagnetic wave, and as a result of the interaction between the light and the atoms in the material, the atoms begin to oscillate and radiate their own electromagnetic radiation. In a sense, the interaction between the light and the charge distribution of the atoms alters the polarization of the light. The superposition of all radiations together with the original wave, results is an electromagnetic wave having the same frequency but a shorter wavelength than the original wave. Since the relation between the frequency and wavelength determines the phase velocity of the light, whereby for a given frequency shorter wavelengths correspond to lower phase velocity, the light is slowed within the material. Once the light exits the material, its original wavelength, hence the phase velocity, is restored.

In many materials, the atomic or molecular structure is such that the phase velocity depends on the propagation direction of the light within the material, hence it is not isotropic. Such materials are called optically anisotropic.

Optical birefringence, also known as double refraction, is an optical phenomenon which is associated with optically anisotropic materials, whereby the material exhibits a different refraction index (hence the light has a different phase velocity) for each of two polarization directions defined by the material. An optically anisotropic material rotates the polarization plane of the light as the light propagates therethrough.

Since optically anisotropic materials exhibits different refraction indices in different directions, their refraction index is a vector quantity, n, commonly written as n=(nₒ, nₑ), where the nₒ is referred to as the ordinary refraction index and nₑ is referred to as the extraordinary refraction index. Also known are more complicated materials for which the refraction index is a tensor quantity.

The level of anisotropy of the material is quantified by a quantity called birefringence. The birefringence can be expressed as an optical path difference, when the light propagates through a unit length of the material. The optical path Λ of the light along a geometrical distance x is defined as Λ=ct, where c is speed of light in the vacuum and t is the propagation time of a single component of the light along the distance x.

A commonly used unit for birefringence is nanometer per centimeter. For example, suppose that when the light propagates along x centimeters of the material in one direction its optical distance is Λ₁ nanometers, and when the light propagates along x centimeters of the material in another direction its optical distance is Λ₂ nanometers. The birefringence of the material is defined as the ratio (Λ₁−Λ₂)/x. The birefringence can also be expressed as a dimensionless quantity, which is commonly defined as the difference between the ordinary and extraordinary refraction indices: Δn=nₒ−nₑ. From the above definition of the optical path and the refraction index it follows that the dimensional and dimensionless definitions of the birefringence are equivalent.

Unless otherwise stated, the term “birefringence” refers herein to the dimensionless definition of the birefringence, Δn=nₑ−nₒ. One of ordinary skills in the art, provided with the details described herein would know how to obtain the dimensional birefringence from its dimensionless equivalent.

Linear diffraction gratings are polarization dependent in the sense that linearly polarized light is diffracted with higher diffraction efficiency when the polarization direction is parallel to the groves of the gratings and with lower diffraction efficiency otherwise. In particular, when the polarization direction is perpendicular to the groves of the gratings diffraction efficiency is generally low.

Thus, if several parallel linear gratings are formed in a substrate with high birefringence, a linearly polarized light propagating in the substrate experiences different diffraction efficiencies at different gratings, because the polarization plane of the light is rotating during the propagation and the light may arrive at different gratings with different polarization directions. This problem is aggravated even in the case of small Δn when the propagation distance of the light in the substrate is of the order of about one centimeter or longer. For such distances, the reduction of diffraction efficiency is substantial and results in loss of information.

In a search for an optical relay device with enhanced optical characteristics, the present Inventors have uncovered that good transmission efficiency can be achieved using materials with substantially low birefringence.

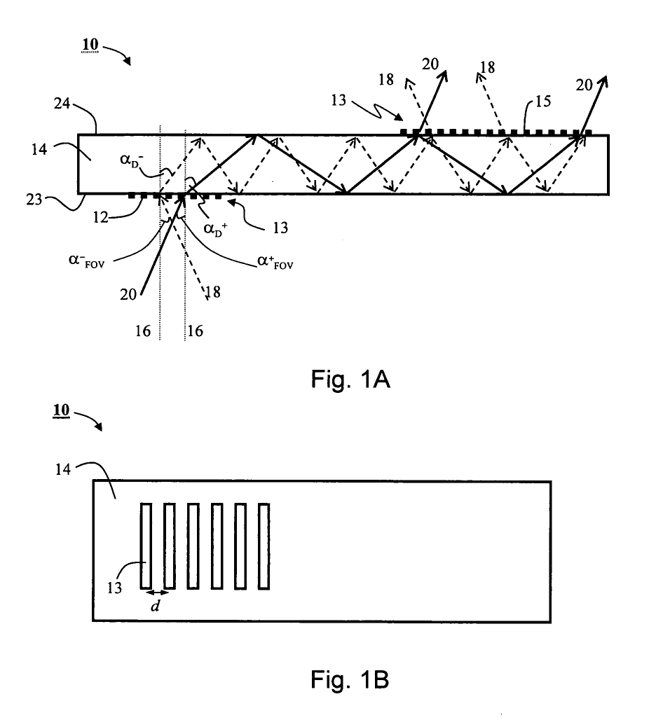

Referring now to the drawings, FIG. 1A illustrates an optical relay device 10, according to various exemplary embodiments of the present invention. Device 10 comprises a substrate 14, having a first surface 22 and a second surface 23. Substrate 14 is made, at least in part, of a light transmissive material characterized by a birefringence, Δn, which is substantially low in its absolute value. Device 10 further comprises one or more diffractive optical elements 13 formed on one or more of the surfaces of substrate 14. A top view of device 10 having a single diffractive optical element is illustrated in FIG. 1B. In the representative example shown in FIG. 1B, diffractive optical element 13 is a linear diffraction grating, characterized by a grating period, d.

The diffraction optical element(s) serves for diffracting light into substrate 14. The term “diffracting” as used herein, refers to a change in the propagation direction of a wavefront, in either a transmission mode or a reflection mode. In a transmission mode, “diffracting” refers to change in the propagation direction of a wavefront while passing through an optical element; in a reflection mode, “diffracting” refers to change in the propagation direction of a wavefront while reflecting off an optical element.

The birefringence of the light transmissive material of the present embodiments preferably satisfies the inequality |Δn|<ε, where ε is lower than the birefringence of polycarbonate. In various exemplary embodiments of the invention ε equals 0.0005, more preferably 0.0004, more preferably 0.0003, even more preferably 0.0002.

In various exemplary embodiments of the invention the light transmissive material comprises a polymer or a copolymer. Polymers or copolymers suitable for the present embodiments are characterized by isotropic optical activity and at least one, more preferably at least two additional characteristics selected from: high transmission efficiency, good molding ability, low moisture permeability, chemical resistance and dimensional stability.

Exemplary light transmissive materials suitable for the present embodiments include, without limitation, cycloolefin polymers, cycloolefin copolymers and other polycyclic polymers from cycloolefinic monomers such as norbornene, hydrocarbyl and/or halogen substituted norbornene-type monomers, polymers and/or copolymers containing N-halogenated phenyl maleimides, N-halogenated phenyl bismaleimides, halogenated acrylates, halogenated styrenes, halogenated vinyl ethers, halogenated olefins, halogenated vinyl isocyanates, halogenated N-vinyl amides, halogenated allyls, halogenated propenyl ethers, halogenated methacrylates, halogenated maleates, halogenated itaconates, halogenated crotonates, and other amorphous transparent plastics.

In various exemplary embodiments of the invention the light transmissive material comprises a cycloolefin polymer or a cycloolefin copolymer, such as those commercially available from suppliers such as Zeon, Japan, under the trade-names Zeonex™ and Zeonor™, from Ticona, a business of Celanese Corporation, USA, under the trade-name Topas™, and from Mitsui Chemicals Group under the trade name APEL™. Although both cycloolefin polymer and cycloolefin copolymer are preferred over the above light transmissive materials, cycloolefin polymer is more favored over cycloolefin copolymer, because the temperature window for fabricating a substrate which comprises a cycloolefin polymer is wider.

A preferred method for manufacturing optical relay device 10 is provided hereinafter.

In the representative illustration of FIG. 1A, device 10 comprises an input optical element 12 and an output optical element 15, which are typically, but not obligatorily, linear diffraction gratings. Element 15 is laterally displaced from element 12 by a few centimeters. When elements 12 and 15 are linear diffraction gratings, the grating lines of element 12 are preferably substantially parallel to the grating lines of element 15. Device 10 is preferably designed to transmit light striking substrate 14 at any striking angle within a predetermined range of angles, which predetermined range of angles is referred to of the field-of-view of the device.

The field-of-view is illustrated in FIG. 1A by its rightmost light ray 18, striking substrate 14 at an angle α⁻_{FOV}, and leftmost light ray 20, striking substrate 14 at an angle α⁺_{FOV}. α⁻_{FOV} is measured anticlockwise from a normal 16 to substrate 14, and α⁺_{FOV} is measured clockwise from normal 16. Thus, according to the above convention, α⁻_{FOV} has a negative value and α⁺_{FOV} has a positive value, resulting in a field-of-view of φ=α⁺_{FOV}+|α⁻_{FOV}|, in inclusive representation.

Input optical element 12 is preferably designed to trap all light rays in the field-of-view within substrate 14. Specifically, when the light rays in the field-of-view impinge on element 12, they are diffracted at a diffraction angle (defined relative to normal 16) which is larger than the critical angle, such that upon striking the other surface of substrate 14, all the light rays of the field-of-view experiences total internal reflection and propagate within substrate 14. The diffraction angles of leftmost ray 20 and rightmost ray 18 are designated in FIG. 1A by α_{D}⁺ and α_{D}⁻, respectively. The propagated light, after a few reflections within substrate 14, reaches output optical element 15 which diffracts the light out of substrate 14. As shown in FIG. 1A, only a portion of the light energy exits substrate 14. The remnant of each ray is redirected through an angle, which causes it, again, to experience total internal reflection from the other side of substrate 14. After a first reflection, the remnant may re-strike element 15, and upon each such re-strike, an additional part of the light energy exits substrate 14.

The diffraction efficiency of elements 12 and 15 is polarization dependent. For example, for linear gratings and a linearly polarized light, the diffraction efficiency depends on the angle between the polarization direction and the grating lines. Specifically, the diffraction efficiency is generally higher when the polarization direction is parallel to the grating lines and lower when the polarization direction is perpendicular to the grating lines. As stated, substrate 14 preferably has a very low birefringence and/or high light transmission. These properties of substrate 14 significantly improve the overall transmission efficiency from element 12 to element 15, because there are minimal or no variations in refraction index of substrate 14 for different polarizations of the light, and there is a minimal or no optical absorbance when the light propagates within substrate 14 from element 12 to element 15.

The light rays arriving to device 10 can have a plurality of wavelengths, from a shortest wavelength, λ_{B}, to a longest wavelength, λ_{R}, referred to herein as the spectrum of the light. In a preferred embodiment in which surfaces 22 and 23 are substantially parallel, elements 12 and 15 can be designed, for a given spectrum, solely based on the value of α⁻_{FOV} and the value of the shortest wavelength λ_{B}. For example, when the diffractive optical elements are linear gratings, the period, d, of the gratings can be selected based α⁻_{FOV} and λ_{B}, irrespectively of the optical properties of substrate 14 or any wavelength longer than λ_{B}.

According to a preferred embodiment of the present invention d is selected such that the ratio λ_{B}/d is from about 1 to about 2. A preferred expression for d is given by the following equation:

d=λ_{B}/[n_{A}(1−sin α⁻_{FOV})]. (EQ. 3)

It is appreciated that the d, as given by Equation 3, is a maximal grating period. Hence, in order to accomplish total internal reflection d can also be smaller than λ_{B}/[n_{A}(1−sin α⁻_{FOV})].

Substrate 14 is preferably selected such as to allow light having any wavelength within the spectrum and any striking angle within the field-of-view to propagate in substrate 14 via total internal reflection.

The substantially low birefringence of substrate 14 allow to accurately design the device to achieve such performance, because there is a minimal or no dependence of the refraction index on the propagation direction of the light. According to a preferred embodiment of the present invention the refraction index of substrate 14 is larger than λ_{R}/d+n_{A} sin(α⁺_{FOV}). More preferably, the refraction index, n_{S}, of substrate 14 satisfies the following equation:

n_{S}≧[λ_{R}/d+n_{A} sin(α⁺_{FOV})]/sin(α_{D}^{MAX}). (EQ. 4)

where α_{D}^{MAX} is the largest diffraction angle, i.e., the diffraction angle of the light ray which arrive at a striking angle of α⁺_{FOV}. In the exemplified illustration of FIG. 1A, α_{D}^{MAX} is the diffraction angle of ray 20. There are no theoretical limitations on α_{D}^{MAX}, except from a requirement that it is positive and smaller than 90 degrees. α_{D}^{MAX} can therefore have any positive value smaller than 90°. Various considerations for the value α_{D}^{MAX} are found in U.S. Pat. No. 6,757,105, the contents of which are hereby incorporated by reference.

The thickness, h, of substrate 14 is preferably from about 0.1 mm to about 5 mm, more preferably from about 1 mm to about 3 mm, even more preferably from about 1 to about 2.5 mm. For multicolor use, h is preferably selected to allow simultaneous propagation of plurality of wavelengths, e.g., h>10 λ_{R}. The width/length of substrate 14 is preferably from about 10 mm to about 100 mm. A typical width/length of the diffractive optical elements depends on the application for which device 10 is used. For example, device 10 can be employed in a near eye display, such as the display described in U.S. Pat. No. 5,966,223, in which case the typical width/length of the diffractive optical elements is from about 5 mm to about 20 mm. The contents of U.S. Patent Application No. 60/716,533, which provides details as to the design of the diffractive optical elements and the selection of their dimensions, are hereby incorporated by reference.

Device 10 is capable of transmitting light having a spectrum spanning over at least 100 nm. More specifically, the shortest wavelength, λ_{B}, generally corresponds to a blue light having a typical wavelength of between about 400 to about 500 nm and the longest wavelength, λ_{R}, generally corresponds to a red light having a typical wavelength of between about 600 to about 700 nm.

As can be understood from the geometrical configuration illustrated in FIG. 1A, the angles at which light rays 18 and 20 diffract can differ. As the diffraction angles depend on the incident angles (see Equation 2, for the case in which element 12 is a linear diffraction grating), the allowed clockwise (α⁺_{FOV}) and anticlockwise (α⁻_{FOV}) field-of-view angles, are also different. Thus, device 10 supports transmission of asymmetric field-of-view in which, say, the clockwise field-of-view angle is greater than the anticlockwise field-of-view angle. The difference between the absolute values of the clockwise and anticlockwise field-of-view angles can reach more than 70% of the total field-of-view.

This asymmetry can be exploited, in accordance with various exemplary embodiments of the present invention, to enlarge the field-of-view of optical relay device 10. According to a preferred embodiment of the present invention, a light-transmissive substrate can be formed with at least one input optical element and two output optical elements. The input optical element(s) serve for diffracting the light into the light-transmissive substrate in a manner such that different portions of the light, corresponding to different partial fields-of-view, propagate within the substrate in different directions to thereby reach the output optical elements. The output optical elements complementarily diffract the different portions of the light out of the light-transmissive substrate.

The terms “complementarily” or “complementary,” as used herein in conjunction with a particular observable or quantity (e.g., field-of-view, image, spectrum), refer to a combination of two or more overlapping or non-overlapping parts of the observable or quantity so as to provide the information required for substantially reconstructing the original observable or quantity.

Any number of input/output optical elements can be used. Additionally, the number of input optical elements and the number of output optical elements may be different, as two or more output optical elements may share the same input optical element by optically communicating therewith. The input and output optical element can be formed on a single substrate or a plurality of substrates, as desired. For example, in one embodiment the input and output optical element are linear diffraction gratings, preferably of identical periods, formed on a single substrate, preferably in a parallel orientation.

If several input/output optical elements are formed on the same substrate, as in the above embodiment, they can engage any side of the substrate, in any combination.

One ordinarily skilled in the art would appreciate that this corresponds to any combination of transmissive and reflective optical elements. Thus, for example, suppose that there is one input optical element, formed on surface 22 of substrate 14 and two output optical elements formed on surface 23. Suppose further that the light impinges on surface 22 and it is desired to diffract the light out of surface 23. In this case, the input optical element and the two output optical elements are all transmissive, so as to ensure that entrance of the light through the input optical element, and the exit of the light through the output optical elements. Alternatively, if the input and output optical elements are all formed on surface 22, then the input optical element remain transmissive, so as to ensure the entrance of the light therethrough, while the output optical elements are reflective, so as to reflect the propagating light at an angle which is sufficiently small to couple the light out. In such configuration, light can enter the substrate through the side opposite the input optical element, be diffracted in reflection mode by the input optical element, propagate within the light transmissive substrate in total internal diffraction and be diffracted out by the output optical elements operating in a transmission mode.

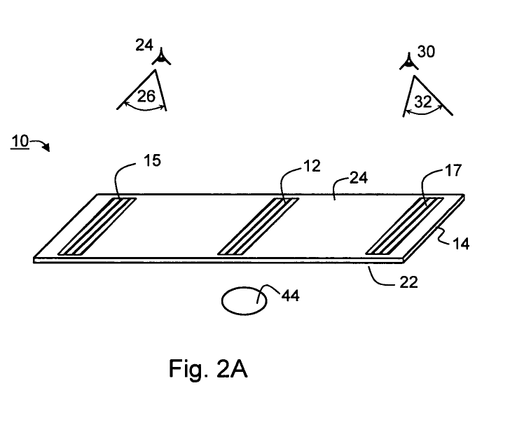

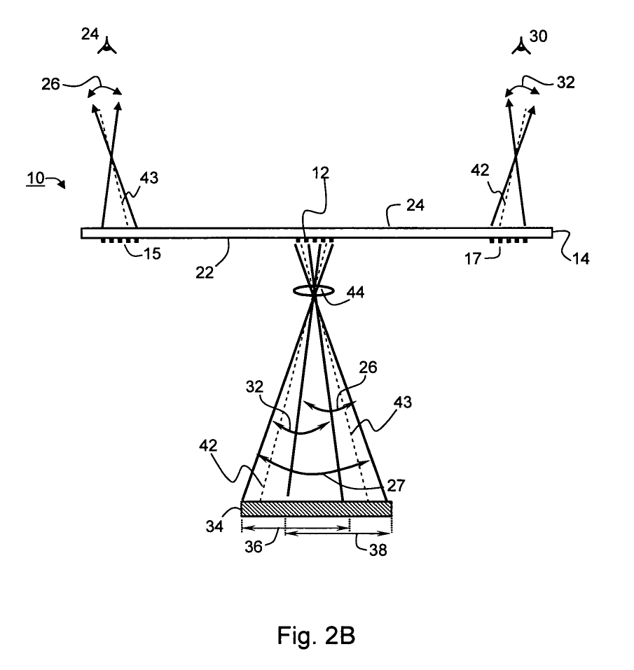

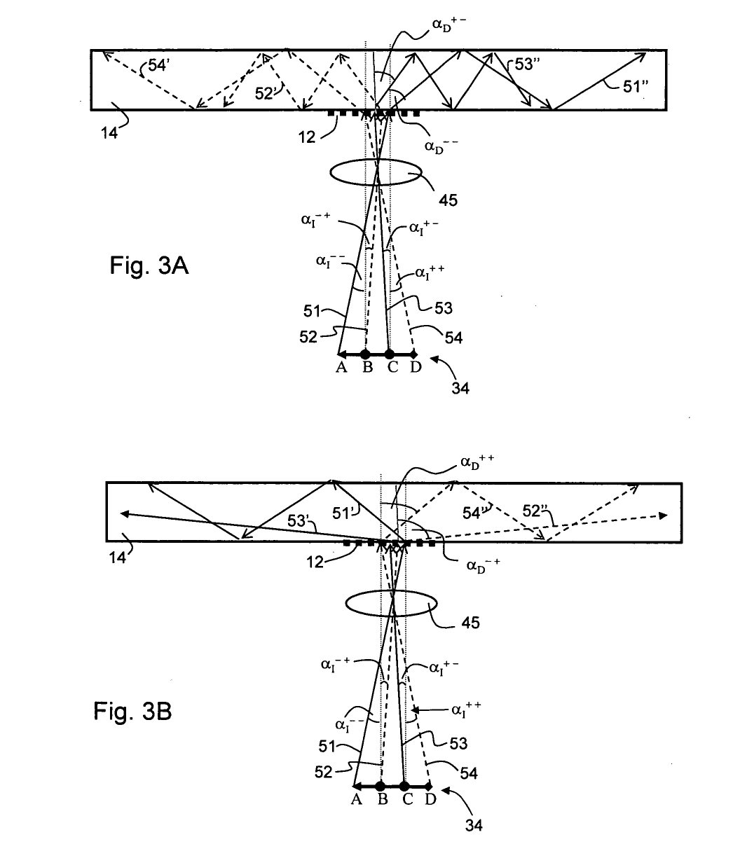

Reference is now made to FIGS. 2A-B which are schematic illustrations of a perspective view (FIG. 2A) and a side view (FIG. 2B) of device 10, in a preferred embodiment in which one input optical element 12 and two output optical elements 15 and 17 are employed. In FIG. 2B, first 15 and second 17 output optical elements are formed, together with input optical element 12, on surface 22 of substrate 14. However, as stated, this need not necessarily be the case, since, for some applications, it may be desired to form the input/output optical elements on any of first 22 or second 23 surface of substrate 14, in an appropriate transmissive/reflective combination. According to a preferred embodiment of the present invention first 22 and second 23 surfaces are substantially parallel. Wavefront propagation within substrate 14, according to various exemplary embodiments of the present invention, is further detailed hereinunder with reference to FIGS. 3A-B.

Element 12 preferably diffracts the incoming light into substrate 14 in a manner such that different portions of the light, corresponding to different partial fields-of-view, propagate in different directions within substrate 14. In the configuration exemplified in FIGS. 2A-B, element 12 diffract light rays within one asymmetric partial field-of-view, designated by reference numeral 26, leftwards to impinge on element 15, and another asymmetric partial field-of-view, designated by reference numeral 32, to impinge on element 17. Elements 15 and 17 complementarily diffract the respective portions of the light, or portions thereof, out of substrate 14, to provide a first eye 24 with partial field-of-view 26 and a second eye 30 with partial field-of-view 32.

Partial fields-of-view 26 and 32 form together the field-of-view 27 of device 10. When device 10 is used for transmitting an image 34, field-of-view 27 preferably includes substantially all light rays originated from image 34. Partial fields-of-view 26 and 32 can correspond to different parts of image 34, which different parts are designated in FIG. 2B by numerals 36 and 38. Thus, as shown in FIG. 2B, there is at least one light ray 42 which enters device 10 via element 12 and exits device 10 via element 17 but not via element 15. Similarly, there is at least one light ray 43 which enters device 10 via element 12 and exits device 10 via element 15 but not via element 17.

Generally, the partial field-of-views, hence also the parts of the image arriving to each eye depend on the wavelength of the light. Therefore, it is not intended to limit the scope of the present embodiments to a configuration in which part 36 is viewed by eye 24 and part 38 viewed by eye 30. In other words, for different wavelengths, part 36 is viewed by eye 30 and part 38 viewed by eye 24. For example, suppose that the image is constituted by a light having three colors: red, green and blue. As demonstrated in the Examples section that follows, device 10 can be constructed such that eye 24 sees part 38 for the blue light and part 36 for the red light, while eye 30 sees part 36 for the blue light and part 38 for the red light. In such configuration, both eyes see an almost symmetric field-of-view for the green light. Thus, for every color, the two partial fields-of-view compliment each other.

The human visual system is known to possess a physiological mechanism capable of inferring a complete image based on several parts thereof, provided sufficient information reaches the retinas. This physiological mechanism operates on monochromatic as well as chromatic information received from the rod cells and cone cells of the retinas. Thus, in a cumulative nature, the two asymmetric field-of-views, reaching each individual eye, form a combined field-of-view perceived by the user, which combined field-of-view is wider than each individual asymmetric field-of-view.

According to a preferred embodiment of the present invention, there is a predetermined overlap between first 26 and second 32 partial fields-of-view, which overlap allows the user's visual system to combine parts 36 and 38 of image 34, thereby to perceive the image, as if it has been fully observed by each individual eye.

For example, as further demonstrated in the Examples section that follows, the diffractive optical elements can be constructed such that the exclusive representations of partial fields-of-view 26 and 32 are, respectively, [−α, β] and [−β, α], resulting in a symmetric combined field-of-view 27 of [−β, β]. It will be appreciated that when β>>α>0, the combined field-of-view is considerably wider than each of the asymmetric field-of-views. Device 10 is capable of transmitting a field-of-view of at least 20 degrees, more preferably at least 30 degrees most preferably at least 40 degrees, in inclusive representation.

When the image is a multicolor image having a spectrum of wavelengths, different sub-spectra correspond to different, wavelength-dependent, asymmetric partial field-of-views, which, in different combinations, form different wavelength-dependent combined fields-of-view. For example, a red light can correspond to a first red asymmetric partial field-of-view, and a second red asymmetric partial field-of-view, which combine to a red combined field-of-view. Similarly, a blue light can correspond to a first blue asymmetric partial field-of-view, and a second blue asymmetric partial field-of-view, which combine to a blue combined field-of-view, and so on. Thus, a multicolor configuration is characterized by a plurality of wavelength-dependent combined field-of-views. According to a preferred embodiment of the present invention the diffractive optical elements are designed and constructed so as to maximize the overlap between two or more of the wavelength-dependent combined field-of-views.

In terms of spectral coverage, the design of device 10 is preferably as follows: element 15 provides eye 24 with, say, a first sub-spectrum which originates from part 36 of image 34, and a second sub-spectrum which originates from part 38 of image 34. Element 17 preferably provides the complementary information, so as to allow the aforementioned physiological mechanism to infer the complete spectrum of the image. Thus, element 17 preferably provides eye 30 with the first sub-spectrum originating from part 38, and the second sub-spectrum originating from part 36.

Ideally, a multicolor image is a spectrum as a function of wavelength, measured at a plurality of image elements. This ideal input, however, is rarely attainable in practical systems. Therefore, the present embodiment also addresses other forms of imagery information. A large percentage of the visible spectrum (color gamut) can be represented by mixing red, green, and blue colored light in various proportions, while different intensities provide different saturation levels. Sometimes, other colors are used in addition to red, green and blue, in order to increase the color gamut. In other cases, different combinations of colored light are used in order to represent certain partial spectral ranges within the human visible spectrum.

In a different form of color imagery, a wide-spectrum light source is used, with the imagery information provided by the use of color filters. The most common such system is using white light source with cyan, magenta and yellow filters, including a complimentary black filter. The use of these filters could provide representation of spectral range or color gamut similar to the one that uses red, green and blue light sources, while saturation levels are attained through the use of different optical absorptive thickness for these filters, providing the well known “grey levels.”

Thus, the multicolored image can be displayed by three or more channels, such as, but not limited to, Red-Green-Blue (RGB) or Cyan-Magenta-Yellow-Black (CMYK) channels. RGB channels are typically used for active display systems (e.g., CRT or OLED) or light shutter systems (e.g., Digital Light Processing™ (DLP™) or LCD illuminated with RGB light sources such as LEDs). CMYK images are typically used for passive display systems (e.g., print). Other forms are also contemplated within the scope of the present invention.

When the multicolor image is formed from a discrete number of colors (e.g., an RGB display), the sub-spectra can be discrete values of wavelength. For example, a multicolor image can be provided by an OLED array having red, green and blue organic diodes (or white diodes used with red, green and blue filters) which are viewed by the eye as continues spectrum of colors due to many different combinations of relative proportions and intensities between the wavelengths of light emitted thereby. For such images, the first and the second sub-spectra can correspond to the wavelengths emitted by two of the blue, green and red diodes of the OLED array, for example the blue and red. As further demonstrated in the Example section that follows, device 10 can be constructed such that, say, eye 30 is provided with blue light from part 36 and red light from part 38 whereas eye 24 is provided with red light from part 36 and blue light from part 38, such that the entire spectral range of the image is transmitted into the two eyes and the physiological mechanism reconstructs the image.

The light arriving at the input optical element of device 10 is preferably collimated. In case the light is not collimated, a collimator 44 can be positioned on the light path between image 34 and the input element.

Collimator 44 can be, for example, a converging lens (spherical or non spherical), an arrangement of lenses and the like. Collimator 44 can also be a diffractive optical element, which may be spaced apart, carried by or formed in substrate 14. A diffractive collimator may be positioned either on the entry surface of substrate 14, as a transmissive diffractive element or on the opposite surface as a reflective diffractive element.

Following is a description of the principles and operations of optical relay device 10, in the embodiment in which device 10 comprises one input optical element and two output optical elements.

Reference is now made to FIGS. 3A-B which are schematic illustrations of wavefront propagation within substrate 14, according to preferred embodiments of the present invention. Shown in FIGS. 3A-B are four light rays, 51, 52, 53 and 54, respectively emitted from four points, A, B, C and D, of image 34. The incident angles, relative to the normal to substrate, of rays 51, 52, 53 and 54 are denoted α_{I}⁻⁻, α_{I}⁻⁺, α_{I}⁺⁻ and α_{I}⁺⁺, respectively. As will be appreciated by one of ordinary skill in the art, the first superscript index refer to the position of the respective ray relative to the center of the field-of-view, and the second superscript index refer to the position of the respective ray relative to the normal from which the angle is measured, according to the aforementioned sign convention.

It is to be understood that this sign convention cannot be considered as limiting, and that one ordinarily skilled in the art can easily practice the present invention employing an alternative convention.

Similar notations will be used below for the diffraction angles of the rays, with the subscript D replacing the subscript I. Denoting the superscript indices by a pair i, j, an incident angle is denoted generally as α_{I}^{ij}, and a diffraction angle is denoted generally as α_{D}^{ij}, where ij=“−−”, “−+”, “+−” or “−−”. The relation between each incident angle, α_{I}^{ij}, and its respective diffraction angle, α_{D}^{ij}, is given by Equation 2, above, with the replacements α_{I}→α_{I}^{ij}, and α_{D}→α_{D}^{ij}.

Points A and D represent the left end and the right end of image 34, and points B and C are located between points A and D. Thus, rays 51 and 53 are the leftmost and the rightmost light rays of a first asymmetric field-of-view, corresponding to a part A-C of image 34, and rays 52 and 54 are the leftmost and the rightmost light rays of a second asymmetric field-of-view corresponding to a part B-D of image 34. In angular notation, the first and second asymmetric field-of-view are, respectively, [α_{I}⁻⁻, α_{I}⁺⁻] and [α_{I}⁻⁺, α_{I}⁺⁺] (exclusive representations). Note that an overlap field-of-view between the two asymmetric field-of-views is defined between rays 52 and 53, which overlap equals [α_{I}⁻⁺, α_{I}⁺⁻] and corresponds to an overlap B-C between parts A-C and B-D of image 34.

In the configuration shown in FIGS. 3A-B, a lens 45 magnifies image 34 and collimates the wavefronts emanating therefrom. For example, light rays 51-54 pass through a center of lens 45, impinge on substrate 14 at angles α_{I}^{ij} and diffracted by input optical element 12 into substrate 14 at angles α_{D}^{ij}. For the purpose of a better understanding of the illustrations in FIGS. 3A-B, only two of the four diffraction angles (to each side) are shown in each figure, where FIG. 3A shows the diffraction angles to the right of rays 51 and 53 (angles α_{D}⁺⁻ and α_{D}⁻⁻), and FIG. 3B shows the diffraction angles to the right of rays 52 and 54 (angles α_{D}⁻⁺ and α_{D}⁺⁺).

Each diffracted light ray experiences a total internal reflection upon impinging on the inner surfaces of substrate 14 if |α_{D}^{ij}|, the absolute value of the diffraction angle, is larger than the critical angle α_{c}. Light rays with |α_{D}^{ij}|<α_{c} do not experience a total internal reflection hence escape from substrate 14. Generally, because input optical element 12 diffracts the light both to the left and to the right, a light ray may, in principle, split into two secondary rays each propagating in an opposite direction within substrate 14, provided the diffraction angle of each of the two secondary rays is larger than α_{c}. To ease the understanding of the illustrations in FIGS. 3A-B, secondary rays diffracting leftward and rightward are designated by a single and double prime, respectively.

Reference is now made to FIG. 3A showing a particular and preferred embodiment in which |α_{D}⁻⁺|=|α_{D}⁺⁻|=α_{c}. Shown in FIG. 3A are rightward propagating rays 51″ and 53″, and leftward propagating rays 52′ and 54′. Hence, in this embodiment, element 12 split all light rays between ray 51 and ray 52 into two secondary rays, a left secondary ray, impinging on the inner surface of substrate 14 at an angle which is smaller than α_{c}, and a right secondary ray, impinging on the inner surface of substrate 14 at an angle which is larger than α_{c}. Thus, light rays between ray 51 and ray 52 can only propagate rightward within substrate 14. Similarly, light rays between ray 53 and ray 54 can only propagate leftward. On the other hand, light rays between rays 52 and 53, corresponding to the overlap between the asymmetric field-of-views, propagate in both directions, because element 12 split each such ray into two secondary rays, both impinging the inner surface of substrate 14 at an angle larger than the critical angle, α_{c}.

Thus, light rays of the asymmetrical field-of-view defined between rays 51 and 53 propagate within substrate 14 to thereby reach second output optical element 17 (not shown in FIG. 3A), and light rays of the asymmetrical field-of-view defined between rays 52 and 54 propagate within substrate 14 to thereby reach first output optical element 15 (not shown in FIG. 3A).

In another embodiment, illustrated in FIG. 3B, the light rays at the largest entry angle split into two secondary rays, both with a diffraction angle which is larger than α_{c}, hence do not escape from substrate 14. However, whereas one secondary ray experience a few reflections within substrate 14, and thus successfully reaches its respective output optical element (not shown), the diffraction angle of the other secondary ray is too large for the secondary ray to impinge the other side of substrate 14, so as to properly propagate therein and reach its respective output optical element.

Specifically shown in FIG. 3B are original rays 51, 52, 53 and 54 and secondary rays 51′, 52″, 53′ and 54″. Ray 54 splits into two secondary rays, ray 54′ (not shown) and ray 54″ diffracting leftward and rightward, respectively. However, whereas rightward propagating ray 54″ diffracted at an angle α_{D}⁺⁺ experiences a few reflection within substrate 14 (see FIG. 3B), leftward propagating ray 54′ either diffracts at an angle which is too large to successfully reach element 15, or evanesces.

Similarly, ray 52 splits into two secondary rays, 52′ (not shown) and 52″ diffracting leftward and rightward, respectively. For example, rightward propagating ray 52″ diffracts at an angle α_{D}⁻⁺>α_{c}. Both secondary rays diffract at an angle which is larger than α_{c}, experience one or a few reflections within substrate 14 and reach output optical element 15 and 17 respectively (not shown). Supposing that α_{D}⁻⁺ is the largest angle for which the diffracted light ray will successfully reach the optical output element 17, all light rays emitted from part A-B of the image do not reach element 17 and all light rays emitted from part B-D successfully reach element 17. Similarly, if angle α_{D}^{←} is the largest angle (in absolute value) for which the diffracted light ray will successfully reach optical output element 15, then all light rays emitted from part C-D of the image do not reach element 15 and all light rays emitted from part A-C successfully reach element 15.

Thus, light rays of the asymmetrical field-of-view defined between rays 51 and 53 propagate within substrate 14 to thereby reach output optical element 15, and light rays of the asymmetrical field-of-view defined between rays 52 and 54 propagate within substrate 14 to thereby reach output optical element 17.

Any of the above embodiments can be successfully implemented by a judicious design of the monocular devices, and, more specifically the input/output optical elements and the substrate.

For example, as stated, the input and output optical elements can be linear diffraction gratings having identical periods and being in a parallel orientation. This embodiment is advantageous because it is angle-preserving. Specifically, the identical periods and parallelism of the linear gratings ensure that the relative orientation between light rays exiting the substrate is similar to their relative orientation before the impingement on the input optical element. Consequently, light rays emanating from a particular point of the overlap part B-C of image 34, hence reaching both eyes, are parallel to each other. Thus, such light rays can be viewed by both eyes as arriving from the same angle in space. It will be appreciated that with such configuration viewing convergence is easily obtained without eye-strain or any other inconvenience to the viewer, unlike the prior art binocular devices in which relative positioning and/or relative alignment of the optical elements is necessary.

According to a preferred embodiment of the present invention the period, d, of the gratings and/or the refraction index, n_{S}, of the substrate can be selected so to provide the two asymmetrical field-of-views, while ensuring a predetermined overlap therebetween. This can be achieved in more than one way.

Hence, in one embodiment, a ratio between the wavelength, λ, of the light and the period, d, is larger than or equal a unity:

λ/d≧1. (EQ. 5)

### This embodiment can be used to provide an optical device operating according to the aforementioned principle in which there is no mixing between light rays of the non-overlapping parts of the field-of-view (see FIG. 3A).

In another embodiment, the ratio % Id is smaller than the refraction index, n_{S}, of the substrate. More specifically, d and n_{S} can be selected to comply with the following inequality:

d>λ/(n_{S}p), (EQ. 6)

where p is a predetermined parameter which is smaller than 1.

The value of p is preferably selected so as to ensure operation of the device according to the principle in which some mixing is allowed between light rays of the non-overlapping parts of the field-of-view, as further detailed hereinabove (see FIG. 3B). This can be done for example, by setting p=sin(α_{D}^{MAX}), where (α_{D}^{MAX}) is a maximal diffraction angle. Because there are generally no theoretical limitations on α_{D}^{MAX} (apart from a requirement that its absolute value is smaller than 90°), it may be selected according to any practical considerations, such as cost, availability or geometrical limitations which may be imposed by a certain miniaturization necessity. Hence, in one embodiment, further referred to herein as the “at least one hop” embodiment, α_{D}^{MAX} is selected so as to allow at least one reflection within a predetermined distance x which may vary from about 30 mm to about 80 mm.

For example, for a glass substrate, with an index of refraction of n_{S}=1.5 and a thickness of 2 mm, a single total internal reflection event of a light having a wavelength of 465 nm within a distance x of 34 mm, corresponds to α_{D}^{MAX}=83.3°.

In another embodiment, further referred to herein as the “flat” embodiment, α_{D}^{MAX} is selected so as to reduce the number of reflection events within the substrate, e.g., by imposing a requirement that all the diffraction angles will be sufficiently small, say, below 80°.

In an additional embodiment, particularly applicable to those situations in the industry in which the refraction index of the substrate is already known (for example when device 10 is intended to operate synchronically with a given device which includes a specific substrate), Equation 6 may be inverted to obtain the value of p hence also the value of α_{D}^{MAX}=sin⁻¹p.

As stated, device 10 can transmit light having a plurality of wavelengths. According to a preferred embodiment of the present invention, for a multicolor image the gratings period is preferably selected to comply with Equation 5, for the shortest wavelength, and with Equation 6, for the longest wavelength. Specifically:

λ_{R}/(n_{S}p)≦d≦λ_{B}, (EQ. 7)

where λ_{B} and λ_{R} are, respectively, the shortest and longest wavelengths of the multicolor spectrum. Note that it follows from Equation 5 that the index of refraction of the substrate should satisfy, under these conditions, n_{S}p≧λ_{R}/λ_{B}.

The grating period can also be smaller than the sum λ_{B}+λ_{R}, for example:

$$d = \frac{{λ}_{B} + {λ}_{R}}{{n}_{S} sin ( {α}_{D}^{MAX} ) + {n}_{A}} . \qquad ( EQ . 8 )$$

According to an additional aspect of the present invention there is provided a system 100 for providing an image to a user in a wide field-of-view.

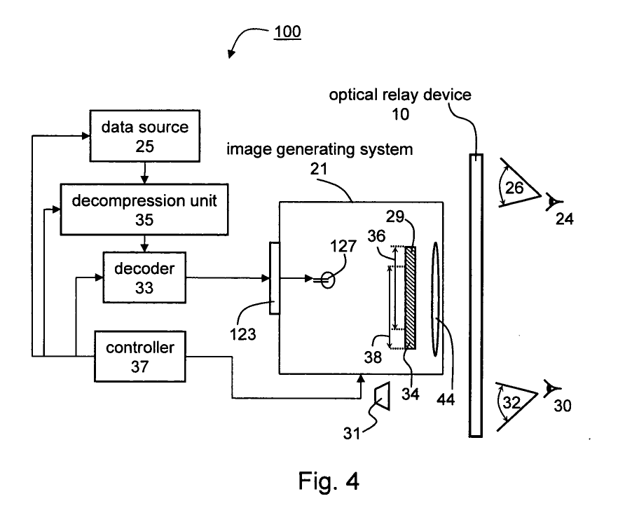

Reference is now made to FIG. 4 which is a schematic illustration of system 100, which, in its simplest configuration, comprises optical relay device 10 for transmitting image 34 into first eye 24 and second eye 30 of the user, and an image generating system 21 for providing optical relay device 10 with collimated light constituting the image.

Image generating system 21 can be either analog or digital. An analog image generating system typically comprises a light source 127, at least one image carrier 29 and a collimator 44. Collimator 44 serves for collimating the input light, if it is not already collimated, prior to impinging on substrate 14. In the schematic illustration of FIG. 4, collimator 44 is illustrated as integrated within system 21, however, this need not necessarily be the case since, for some applications, it may be desired to have collimator 44 as a separate element. Thus, system 21 can be formed of two or more separate units. For example, one unit can comprise the light source and the image carrier, and the other unit can comprise the collimator. Collimator 44 is positioned on the light path between the image carrier and the input element of device 10.

Any collimating element known in the art may be used as collimator 44, for example a converging lens (spherical or non spherical), an arrangement of lenses, a diffractive optical element and the like. The purpose of the collimating procedure is for improving the imaging ability.

In case of a converging lens, a light ray going through a typical converging lens that is normal to the lens and passes through its center, defines the optical axis. The bundle of rays passing through the lens cluster about this axis and may be well imaged by the lens, for example, if the source of the light is located as the focal plane of the lens, the image constituted by the light is projected to infinity.

Other collimating means, e.g., a diffractive optical element, may also provide imaging functionality, although for such means the optical axis is not well defined. The advantage of a converging lens is due to its symmetry about the optical axis, whereas the advantage of a diffractive optical element is due to its compactness.

Representative examples for light source 127 include, without limitation, a lamp (incandescent or fluorescent), one or more LEDs or OLEDs, and the like. Representative examples for image carrier 29 include, without limitation, a miniature slide, a reflective or transparent microfilm and a hologram. The light source can be positioned either in front of the image carrier (to allow reflection of light therefrom) or behind the image carrier (to allow transmission of light therethrough). Optionally and preferably, system 21 comprises a miniature CRT. Miniature CRTs are known in the art and are commercially available, for example, from Kaiser Electronics, a Rockwell Collins business, of San Jose, Calif.

A digital image generating system typically comprises at least one display and a collimator. The use of certain displays may require, in addition, the use of a light source. In the embodiments in which system 21 is formed of two or more separate units, one unit can comprise the display and light source, and the other unit can comprise the collimator.

Light sources suitable for a digital image generating system include, without limitation, a lamp (incandescent or fluorescent), one or more LEDs (e.g., red, green and blue LEDs) or OLEDs, and the like. Suitable displays include, without limitation, rear-illuminated transmissive or front-illuminated reflective LCD, OLED arrays, Digital Light Processing™ (DLP™) units, miniature plasma display, and the like. A positive display, such as OLED or miniature plasma display, may not require the use of additional light source for illumination. Transparent miniature LCDs are commercially available, for example, from Kopin Corporation, Taunton, Mass. Reflective LCDs are are commercially available, for example, from Brillian Corporation, Tempe, Ariz. Miniature OLED arrays are commercially available, for example, from eMagin Corporation, Hopewell Junction, N.Y. DLP™ units are commercially available, for example, from Texas Instruments DLP™ Products, Plano, Tex. The pixel resolution of the digital miniature displays varies from QVGA (320×240 pixels) or smaller, to WQUXGA (3840×2400 pixels).

System 100 is particularly useful for enlarging a field-of-view of devices having relatively small screens. For example, cellular phones and personal digital assistants (PDAs) are known to have rather small on-board displays. PDAs are also known as Pocket PC, such as the trade name iPAQ™ manufactured by Hewlett-Packard Company, Palo Alto, Calif. The above devices, although capable of storing and downloading a substantial amount of information in a form of single frames or moving images, fail to provide the user with sufficient field-of-view due to their small size displays.

Thus, according to a preferred embodiment of the present invention system 100 comprises a data source 25 which can communicate with system 21 via a data source interface 123. Any type of communication can be established between interface 123 and data source 25, including, without limitation, wired communication, wireless communication, optical communication or any combination thereof. Interface 123 is preferably configured to receive a stream of imagery data (e.g., video, graphics, etc.) from data source 25 and to input the data into system 21. Many types or data sources are contemplated. According to a preferred embodiment of the present invention data source 25 is a communication device, such as, but not limited to, a cellular telephone, a personal digital assistant and a portable computer (laptop). Additional examples for data source 25 include, without limitation, television apparatus, portable television device, satellite receiver, video cassette recorder, digital versatile disc (DVD) player, digital moving picture player (e.g., MP4 player), digital camera, video graphic array (VGA) card, and many medical imaging apparatus, e.g., ultrasound imaging apparatus, digital X-ray apparatus (e.g., for computed tomography) and magnetic resonance imaging apparatus.

In addition to the imagery information, data source 25 may generates also audio information. The audio information can be received by interface 123 and provided to the user, using an audio unit 31 (speaker, one or more earphones, etc.).

According to various exemplary embodiments of the present invention, data source 25 provides the stream of data in an encoded and/or compressed form. In these embodiments, system 100 further comprises a decoder 33 and/or a decompression unit 35 for decoding and/or decompressing the stream of data to a format which can be recognized by system 21. Decoder 33 and decompression unit 35 can be supplied as two separate units or an integrated unit as desired.

System 100 preferably comprises a controller 37 for controlling the functionality of system 21 and, optionally and preferably, the information transfer between data source 25 and system 21. Controller 37 can control any of the display characteristics of system 21, such as, but not limited to, brightness, hue, contrast, pixel resolution and the like. Additionally, controller 37 can transmit signals to data source 25 for controlling its operation. More specifically, controller 37 can activate, deactivate and select the operation mode of data source 25. For example, when data source 25 is a television apparatus or being in communication with a broadcasting station, controller 37 can select the displayed channel; when data source 25 is a DVD or MP4 player, controller 37 can select the track from which the stream of data is read; when audio information is transmitted, controller 37 can control the volume of audio unit 31 and/or data source 25.

System 100 or a portion thereof (e.g., device 10) can be integrated with a wearable device, such as, but not limited to, a helmet or spectacles, to allow the user to view the image, preferably without having to hold optical relay device 10 by hand.

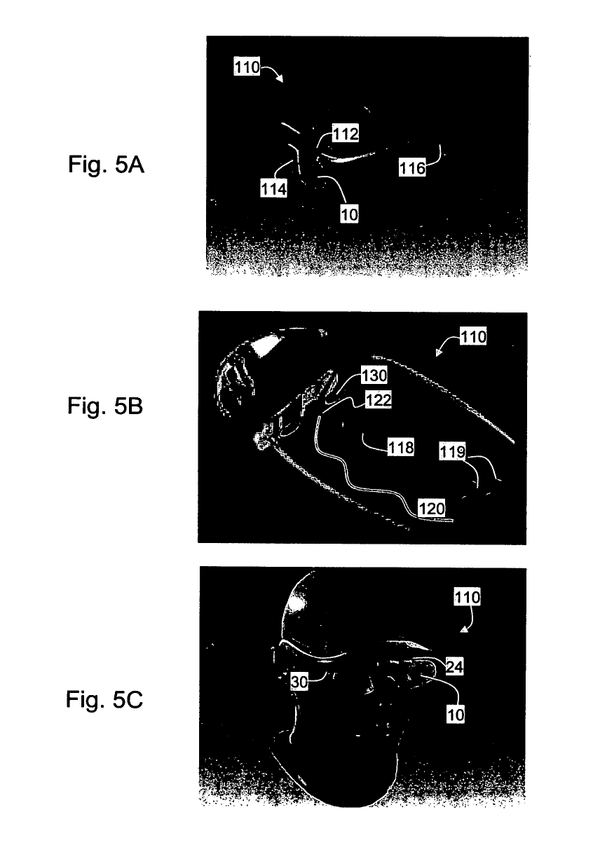

Device 10 can also be used in combination with a vision correction device 130 (not shown, see FIG. 5), for example, one or more corrective lenses for correcting, e.g., short-sightedness (myopia). In this embodiment, the vision correction device is preferably positioned between the eyes and device 20. According to a preferred embodiment of the present invention system 100 further comprises correction device 130, integrated with or mounted on device 10.

Alternatively system 100 or a portion thereof can be adapted to be mounted on an existing wearable device. For example, in one embodiment device 10 is manufactured as a spectacles clip which can be mounted on the user's spectacles, in another embodiment, device 10 is manufactured as a helmet accessory which can be mounted on a helmet's screen.

Reference is now made to FIGS. 5A-C which illustrate a wearable device 110 in a preferred embodiment in which spectacles are used. According to the presently preferred embodiment of the invention device 110 comprises a spectacles body 112, having a housing 114, for holding image generating system 21 (not shown, see FIG. 4); a bridge 122 having a pair of nose clips 118, adapted to engage the user's nose; and rearward extending arms 116 adapted to engage the user's ears. Optical relay device 10 is preferably mounted between housing 114 and bridge 122, such that when the user wears device 110, element 17 is placed in front of first eye 24, and element 15 is placed in front of second eye 30. According to a preferred embodiment of the present invention device 110 comprises a one or more earphones 119 which can be supplied as separate units or be integrated with arms 116.

Interface 123 (not explicitly shown in FIGS. 5A-C) can be located in housing 114 or any other part of body 112. In embodiments in which decoder 33 is employed, decoder 33 can be mounted on body 112 or supplied as a separate unit as desired. Communication between data source 25 and interface 123 can be, as stated, wireless, in which case no physical connection is required between wearable device 110 and data source 25. In embodiments in which the communication is not wireless, suitable communication wires and/or optical fibers 120 are used to connect interface 123 with data source 25 and the other components of system 100.

The present embodiments can also be provided as add-ons to the data source or any other device capable of transmitting imagery data. Additionally, the present embodiments can also be used as a kit which includes the data source, the image generating system, the binocular device and optionally the wearable device. For example, when the data source is a communication device, the present embodiments can be used as a communication kit.

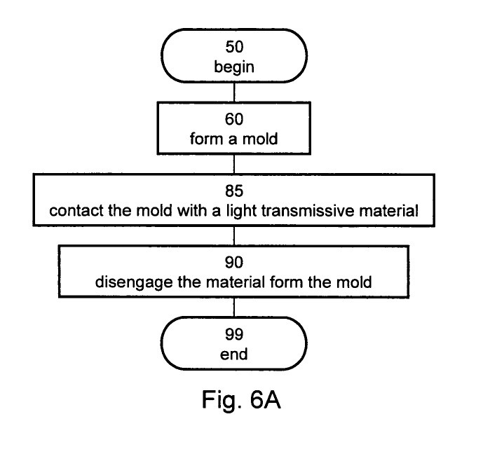

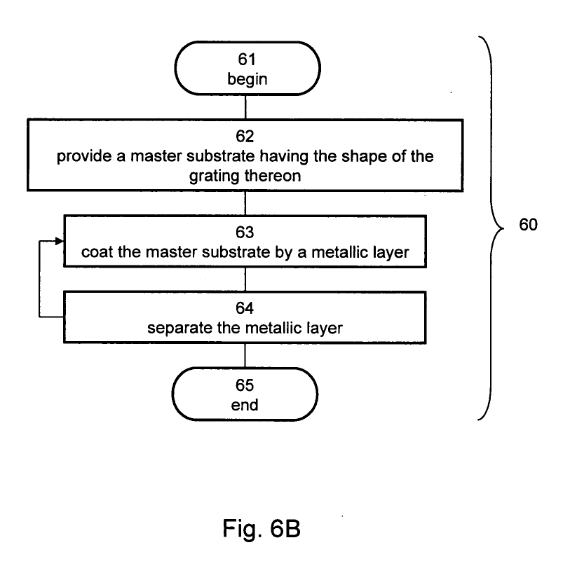

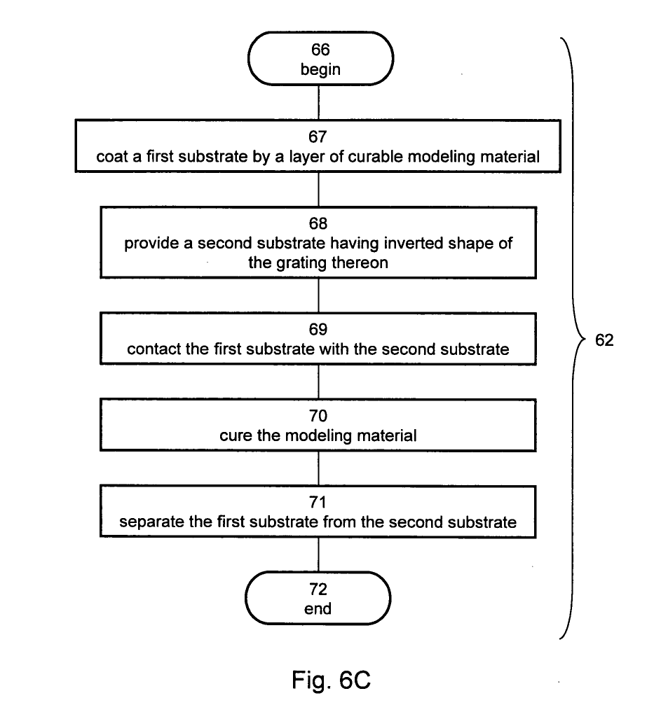

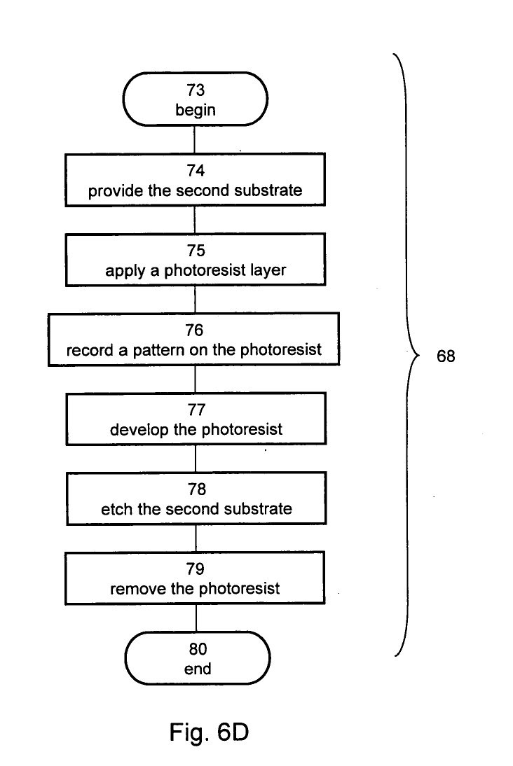

The present embodiments successfully provide a method suitable for manufacturing the optical relay device, in the preferred embodiments in the optical relay device comprises one or more diffraction gratings. The method according to various exemplary embodiments of the present invention is illustrated in the flowchart diagrams of FIGS. 6A-D.

It is to be understood that, unless otherwise defined, the method steps described hereinbelow can be executed either contemporaneously or sequentially in many combinations or orders of execution. Specifically, the ordering of the flowchart diagrams of FIGS. 6A-D is not to be considered as limiting. For example, two or more method steps, appearing in the following description or in the flowchart of FIGS. 6A-D in a particular order, can be executed in a different order (e.g., a reverse order) or substantially contemporaneously. Additionally, several method steps described below are optional and may not be executed.

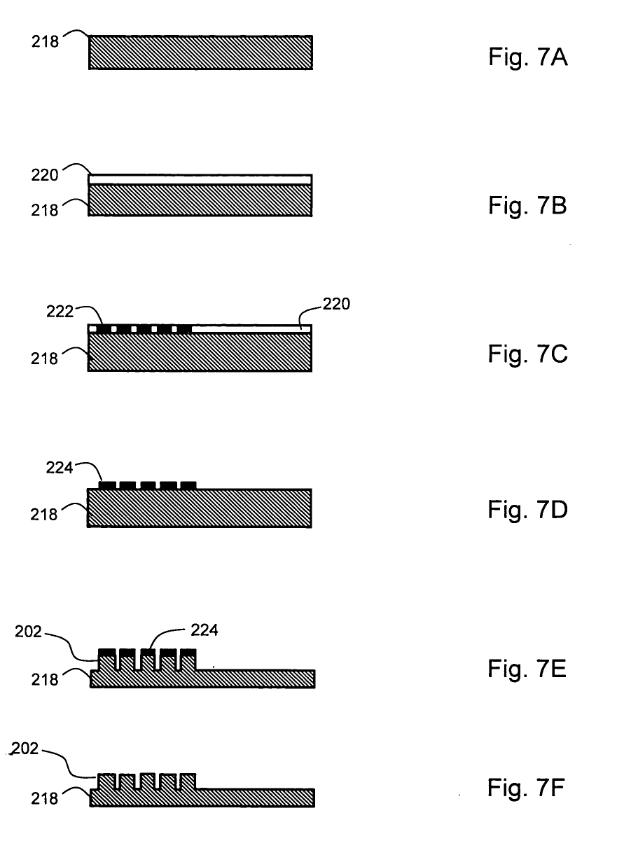

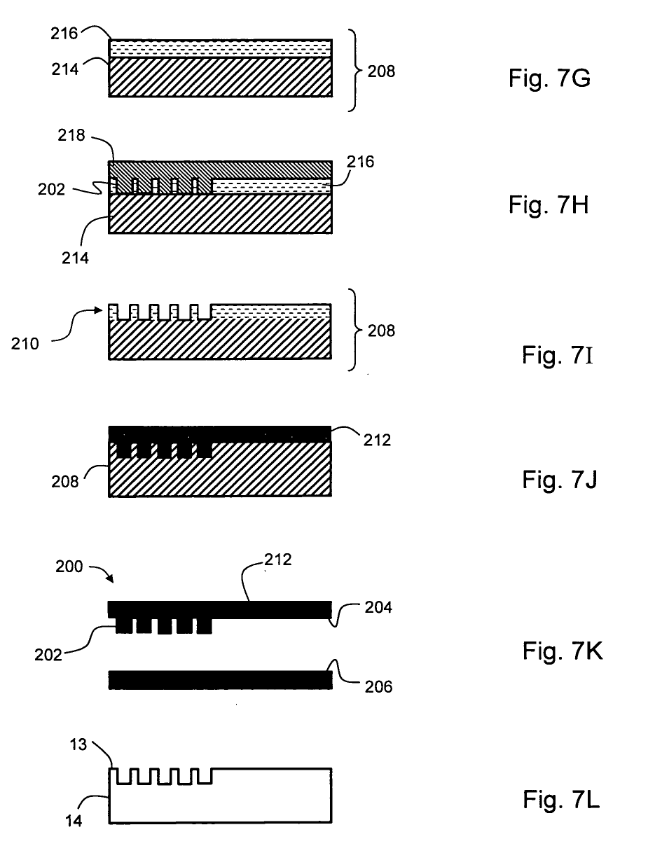

An exemplified process for manufacturing the optical relay device, according to a preferred embodiment of the present invention is provided in the Examples section that follows (see Example 1 and the schematic process illustrations of FIGS. 7A-L).

The method begins at step 50 and continues to step 60 in which a mold having one or more patterns corresponding to an inverted shape of the linear grating is formed. The number of patterns equals the number of linear gratings which are to be formed on the substrate of the optical relay device. The mold can be formed by any technique known in the art. A preferred method for forming the mold is described hereinunder. A schematic illustration of a mold 200 and an inverted shape 202 of one linear grating is provided in FIG. 7K.

Mold 200 is preferably made of metal, e.g., nickel or aluminum, and can comprise one or two surfaces, generally shown at 204 and 206. Shown in FIG. 7K is an exemplified configuration in which surface 204 has the inverted shape of the grating while surface 206 is substantially flat. This embodiment is useful when it is desired to manufacture am optical relay in which all the gratings are formed on one surface of the substrate (say, surface 22, see FIG. 2B). When it is desired to form gratings on both surfaces of the optical relay device (surfaces 22 and 24, see FIG. 1A) both surfaces 204 and 206 of mold 200 include the inverted shape of the gratings.

The method continues to step 85 in which mold 200 is contacted with a light transmissive material which is characterized by a substantially low birefringence, as further detailed above. This can be done in more than one way.

In one embodiment, an injection molding technique is employed. In this embodiment, the mold is heated while being closed and the light transmissive material is introduced into the mold by injection. The injection of the light transmissive material is performed such as to substantially fill the mold. Once the material is injected to the mold, a high pressure can be applied between the two surfaces of the mold, so as to enhance the surface relief replication.

In another embodiment, an injection compression molding technique is employed. In this embodiment, the mold is heated and the light transmissive material is injected into the mold before the closure of the mold such that the mold is only partially filled. Once the material is injected to the mold, the mold is closed to its final position so as to shape the material according to the shape of the mold. High pressure can be applied between the two surfaces of the mold, so as to enhance the surface relief replication.

In an additional embodiment, a varying temperature protocol is employed. In this embodiment, the mold is first heated to a temperature to above the glass transition temperature of the material. Above this temperature, non-covalent bonds become weak in comparison to the thermal motion, and the material is capable of plastic deformation without fracture. This procedure reduces the internal stresses and the variations in the refractive index of the formed substrate. The advantage of this embodiment is that the high temperature of the mold facilitates optimal filling of the mold and replication of the nano-structures. Subsequently to the heating of the mold, the material is injected into the mold and the temperature of the mold is reduced to allow solidification of the material.

The light transmissive material is hardened within the mold and a substrate having the linear grating(s) thereon is thus formed.

The temperatures of the mold and the injected light transmissive material depend, in principle, on the type and amount of material injected into the mold. For example, when the light transmissive material is cycloolefin copolymer or cycloolefin polymer, the melt temperature of the light transmissive material is from about 200° C. to about 320° C. For such materials, fixed temperature protocol can be performed at mold temperature from about 90° C. to about 150° C., and varying temperature protocol can be performed at initial temperature of from about 110° C. to about 180° C., and a final temperature of from about 90° C. to about 140° C.

In still another embodiment, the light transmissive material is in the form of a solid substrate having optically flat surfaces, preferably parallel. The substrate can be fabricated in any way known in the art or any of the processes described herein. In this embodiment, one or more surfaces of the substrate are preferably coated prior to the contacting step mold with one or more layers of materials suitable for three-dimensional object construction, optionally and preferably including a layer of adhesion promotion material located between the substrate and the molded coat layer. The coating material may be of various types, including, without limitation a modeling material which may solidify to form a solid layer of material upon curing. For example, the substrate can be coated with a material having a photopolymer component curable by the application of electromagnetic radiation. The coated substrate is then pressed against the mold and is irradiated by the curing radiation to cure the layers. The thickness of the modeling material is preferably a few hundreds of microns and the thickness of the adhesion promotion layer is preferably from a few microns to a few tens of microns.

In various exemplary embodiments of the invention the substrate is coated with a material having a curable component, such as a photo initiator. In these embodiments, once the coated substrate is pressed against the mold, a curing radiation is applied to cure the layers. The curing radiation can be applied through the substrate, or through the mold if it is made of radiation-transparent material. To enhance adhesion of the modeling material to the substrate material, an adhesion promoter can be applied on the surface(s) of the substrate.

The photo initiator may initiate polymerization of the transmissive material and/or the adhesion promoter.

The term “photo initiator”, as used herein, refers to a substance which may be chemically activated upon exposure to light, and the chemical activation is directed towards initiating a polymerization process between one or more polymerizable monomers in the material for coating the substrate.

In various exemplary embodiments of the invention the photo initiator comprises a UV curable component, in which case the curing radiation is a UV radiation having a wavelength ranging from about 100 nm to about 400 nm. For example, the photo initiator may be activated by UV radiation ranging from approximately 280 nm to approximately 400 nm.

The photo initiator may be a charge-driven photo initiator or a free radical-driven photo initiator, depending on the type of transmissive polymeric materials and/or the adhesion promoter that is used for the substrate coating.

The photo initiator may form a part of one or more monomers used for the polymer comprising the transmission material, by containing a free radical-driven polymerizable group and/or charge-driven polymerizable group (such as for a cationic ring opening polymerization process). The resulting polymer may therefore contain a UV curable component in the form of special functional groups. Such polymer is then blended with a free radical-driven and/or a charge-driven photo initiator and processed into the coating layer on the substrate. Upon exposure to the UV radiation, the photo initiator may produce cations or free radicals, which initiate polymerization of the transmissive polymeric materials and/or the adhesion promoter. For example, in embodiments wherein the transmissive polymeric materials and/or the adhesion promoter include monoacrylate, diacrylates, methacrylate and/or polyacrylate groups, the photo initiator may be a free radical-driven photo initiator. In embodiments wherein the transmissive polymeric materials and/or the adhesion promoter include vinyl, cycloolefin, epoxide and/or oxetane groups, a charge-driven photo initiator may be used. During photolysis, many charge-driven photo initiators generate free radicals in addition to cations, therefore, a preferred photo initiator which may be used to initiate polymerization of the transmissive polymeric materials and/or the adhesion promoter, includes a mixture of acrylate or methacrylate groups and vinyl, epoxide, or oxetane groups.

Exemplary free radical-driven photo initiators include, without limitation: acyloin and derivatives thereof such as benzoin, benzoin methyl ether benzoin ethyl ether, benzoin isopropyl ether, benzoin isobutyl ether, desyl bromide, and α-methylbenzoin; diketones, such as benzil and diacetyl; an organic sulfide, such as diphenyl monosulfide, diphenyl disulfide, desyl phenyl sulfide, and tetramethylthiuram monosulfide; a thioxanthone; an S-acyl dithiocarbamate, such as S-benzoyl-N,N-dimethyldithiocarbamate and S-(p-chlorobenzoyl)-N,N-dimethyldithiocarbamate; a phenone, such as acetophenone, α,α,α-tribromoacetophenone, o-nitro-α,α,α-tribromoacetophenone, benzophenone, and p,p′-tetramethyldiaminobenzophenone; a quinone; a triazole; a sulfonyl halide, such as p-toluenesulfonyl chloride; a phosphorus-containing photo initiator, such as an acylphosphine oxide; an acrylated amine; 2,2-dimethoxy-2-phenylacetophenone, acetophenone, benzophenone, xanthone, 3-methylacetophenone, 4-chlorobenzophenone, 4,4′-dimethoxybenzophenone, benzoin propyl ether, benzyl dimethyl ketal, N,N,N′,N′-tetramethyl-4,4′-diaminobenzophenone, 1-(4-isopropylphenyl)-2-hydroxy-2-methylpropane-1-one, and other thioxanthone compounds; and mixtures thereof.

Exemplary charge-driven photo initiators include, without limitation: an onium salt, such as a sulfonium salt, an iodonium salt, or mixtures thereof; a bis-diaryliodonium salt, a diaryliodonium salt of sulfonic acid, a triarylsulfonium salt of sulfonic acid, a diaryliodonium salt of boric acid, a diaryliodonium salt of boronic acid, a triarylsulfonium salt of boric acid, a triarylsulfonium salt of boronic acid, or mixtures thereof; diaryliodonium hexafluoroantimonate, aryl sulfonium hexafluorophosphate, aryl sulfonium hexafluoroantimonate, bis(dodecyl phenyl) iodonium hexafluoroarsenate, tolyl-cumyliodonium tetrakis(pentafluorophenyl) borate, bis(dodecylphenyl) iodonium hexafluoroantimonate, dialkylphenyl iodonium hexafluoroantimonate, diaryliodonium salts of perfluoroalkylsulfonic acids, such as diaryliodonium salts of perfluorobutanesulfonic acid, perfluoroethanesulfonic acid, perfluorooctanesulfonic acid, and trifluoromethane sulfonic acid; diaryliodonium salts of aryl sulfonic acids such as diaryliodonium salts of para-toluene sulfonic acid, dodecylbenzene sulfonic acid, benzene sulfonic acid, and 3-nitrobenzene sulfonic acid; triarylsulfonium salts of perfluoroalkylsulfonic acids such as triarylsulfonium salts of perfluorobutanesulfonic acid, perfluoroethanesulfonic acid, perfluorooctanesulfonic acid, and trifluoromethane sulfonic acid; triarylsulfonium salts of aryl sulfonic acids such as triarylsulfonium salts of para-toluene sulfonic acid, dodecylbenzene sulfonic acid, benzene sulfonic acid, and 3-nitrobenzene-sulfonic-acid; diaryliodonium salts of perhaloarylboronic acids, triarylsulfonium salts of perhaloarylboronic acid, and mixtures thereof.

The phrase “adhesion promoter” as used herein refers to a substance which is added to the coating material so as to enhance the adhesion of the coating material to the substrate.

Typically the adhesion promoter comprises one or more types of polymerizable monomers having two or more polymerizable functional groups, which upon polymerization can enhance the adhesion of the coating layer, for example by cross-linking the coating material with the substrate. Additional attributes which the adhesion promoter may bestow on the coating layer include physical properties such as abrasion resistance, back mark retention, proper sliding friction and others. Preferred adhesion promoters, according to embodiments of the present invention include, without limitation, water soluble polymers, hydrophilic colloids or water insoluble polymers, latex or dispersions; styrene and derivatives thereof, acrylic acid or methacrylic acid and derivatives thereof, olefins, chlorinated olefins, cycloolefins, (meth)acrylonitriles, itaconic acid and derivatives thereof, maleic acid and derivatives thereof, vinyl halides, vinylidene halides, vinyl monomer having a primary amine addition salt, vinyl monomer containing an aminostyrene addition salt, polyurethanes and polyesters and others; and mixtures thereof. Also included are adhesion promoting polymers such as disclosed in, for example, U.S. Pat. Nos. 6,171,769 and 6,077,656.

When using an adhesion promoter, the layer coating the substrate is subsequently cross linked by exposure to UV radiation and then may be further set thermally.

In an additional embodiment, one or more surfaces of the substrates are coated with one or more layers of a soft thermally settable material. The mold is heated and the coated substrate is then pressed against the mold to thermally set (harden) the thermally settable material. To enhance adhesion, an adhesion promoter can be applied on the surface(s) of the substrate.

Thermally settable polymers are known in the art and found, e.g., in U.S. Pat. Nos. 6,197,486, 6,197,486, 6,207,361, 6,436,619, 6,465,140 and 6,566,033. Suitable classes of thermally settable polymers according to the present invention include polymers of alpha-beta unsaturated monomers, polyesters, polyamides, polycarbonates, cellulosic esters, polyvinyl resins, polysulfonamides, polyethers, polyimides, polyurethanes, polyphenylenesulfides, polytetrafluoroethylene, polyacetals, polysulfonates, polyester ionomers, and polyolefin ionomers. Interpolymers and/or mixtures thereof. Exemplary polymers of alpha-beta unsaturated monomers include polymers of ethylene, propylene, hexene, butene, octene, vinylalcohol, acrylonitrile, vinylidene halide, salts of acrylic acid, salts of methacrylic acid, tetrafluoroethylene, chlorotrifluoroethylene, vinyl chloride, and styrene.

In various exemplary embodiments of the invention the method continues to step 90 in which the substrate is disengaged from the mold. FIG. 7L schematically illustrates the substrate 14 and the linear grating(s) 13 formed thereon, after the disengagement of the substrate from the mold.

The method ends at step 99.

Reference is now made to FIG. 6B which is a flowchart diagram further detailing a method suitable for forming the mold (step 60 in FIG. 6A), according to various exemplary embodiments of the present invention. The method begins at step 61 and continues to step 62 in which a master substrate 208 having the shape 210 of the gratings form thereon is provided (see FIG. 71). A preferred method for forming such master substrate is described hereinunder.

The method continues to step 63 in which master substrate 208 is coated by one or more metallic layers 212 (see FIG. 7J). The metallic layers can be made of any metal suitable for forming molds, such as, but not limited to, aluminum, nickel or any other suitable metal alloy as known in the art. The metallic layer(s) can be applied by any technique known in the art, including, without limitation, physical vapor deposition (PVD), chemical vapor deposition (CVD), atomic layer deposition (ALD), electrochemical plating (ECP) or combination thereof. In the case of more than one metallic layers, the first layer can be deposited formed by PVD, ALD and the other layers can be electroplated on the first layer.

Any of the above coating techniques are well known to those skilled in the art of coating and thin film deposition. In CVD, for example, the metallic layers are formed by placing the master substrate in a mixture of gases. Under certain pressure and temperature conditions, the molecules contained in the gases are deposited on the surfaces of the master substrate as a result of thermal reactions to form the metallic layer thereupon. CVD process can be done in a conventional CVD reactor such as, for example, the CVD reactor disclosed in U.S. Pat. Nos. 5,503,875, 5,441,570, and 6,983,620.

In ALD, the metallic layers are formed on the master substrate by chemically sorbing one or more precursors which comprise the desired metal and a ligand onto the master substrate surface to form a monolayer of precursors that is approximately one molecule thick. A second precursor may be introduced to chemically react with the first chemisorbed layer to grow a thin film on the master substrate surface. After sufficient process cycles of monolayer formation has occurred, or alternatively with the formation of the monolayers, the monolayers can be contacted with a reaction gas to form the metallic layer on the surface of the master substrate. ALD process can be done in any ALD reactor such as, for example, the ALD reactor disclosed in U.S. Pat. Nos. 6,787,463, 6,808,978, 6,869,876 and 7,037,574.

In PVD, the metallic layers are deposited on the master substrate by physical, as opposed to chemical, means. Typically, the deposition of the metallic layer is by sputtering, in which ions are created by collisions between gas atoms and electrons in a glow discharge. The ions are accelerated and directed to a cathode of sputter target material by an electromagnetic field causing atoms of the sputter target material to be ejected from the cathode surface, thereby forming sputter material plasma. By contacting the master substrate with the plasma, the metallic layers are deposited on the surface of the master substrate. PVD process can be done in any conventional magnetron, such as the magnetron disclosed in U.S. Pat. Nos. 4,441,974, 4,931,158, 5,693,197 and 6,570,172.

In ECP, a seed layer is first formed over the surface of the master substrate and subsequently the master substrate is exposed to an electrolyte solution while an electrical bias is simultaneously applied between the master substrate and an anode positioned within the electrolyte solution. The electrolyte solution is generally rich in ions to be plated onto the surface of the master substrate. Therefore, the application of the electrical bias causes the ions to be urged out of the electrolyte solution and to be plated onto the seed layer. ECP process can be done in any way known in the art such as, for example, the techniques disclosed in U.S. Pat. Nos. 6,492,269, 6,638,409, 6,855,037 and 6,939,206.

The method continues to step 64 in which metallic layer or layers 212 are separated from the master substrate 208 to form one surface (e.g., surface 204) of mold 200. In the embodiment in which both surfaces of the mold are patterned according to the inverted shape of the linear grating, the method loops back to step 63 to fabricate the other surface.

The method for forming the mold ends at step 65.

Reference is now made to FIG. 6C which is a flowchart diagram of a method for forming a master substrate, according to various exemplary embodiments of the present invention. The master substrate can be used for forming the mold as described above.

The method begins at step 66 and continues to step 67 in which a first substrate 214 (see FIG. 7G) is coated by one or more layers 216 of a curable modeling material. First substrate is preferably made of a hard material, such as, but not limited to, glass, fused silica, hard plastic, metal and the like. The method continues to step 68 in which a second substrate 218 having the inverted shape 202 of the linear grating is provided. Second substrate 218 is also made of hard material, such as, but not limited to, fused silica, quartz, borosilicate and the like. Second substrate 218 can be fabricated using any technique known in the art for forming either holographic or ruled diffraction gratings.

Thus, substrate 218 can be manufactured classically with the use of a ruling engine, e.g., by burnishing grooves with a diamond stylus in substrate 218, or holographically through a combination of photolithography and etching. A preferred method for forming the second substrate by lithography followed by etching is described hereinunder.

The curable modeling material is capable of solidifying to form a solid layer of material upon curing, as described above. The curable modeling material serves for hosting the shape 210 of the gratings, and is preferably selected to facilitate the aforementioned separation of the metallic layer from the master substrate. In this respect, the hardness of the modeling material in its cured state is preferably lower than the hardness of the metallic layer(s) 212. Additionally, the hardness of the modeling material in its cured state is preferably lower than the hardness of second substrate 218. In various exemplary embodiments of the invention the curable modeling material comprises a UV curable component.

The method continues to step 69 in which first substrate 214 is contacted with second substrate 218 (see FIG. 7H). The method continues to step 70 in which the modeling material is cured. The curing procedure depends on the type of modeling material. For example, when the material is curable by certain electromagnetic radiation (e.g., UV radiation), the curing is by applying the electromagnetic radiation. When the material is curable by thermal treatment, the curing is by thermal treatment, e.g., heating.

The method continues to step 71 in which first substrate 214 is separated from second substrate 218 to expose the cured layer on first substrate 214, thereby forming the master substrate 208 having the shape 210 of the gratings (see FIG. 71).

The method for forming the master substrate ends at step 72.

Reference is now made to FIG. 6D which is a flowchart diagram of a method for forming a substrate having the inverted shape of the linear grating, according to various exemplary embodiments of the present invention. This method is useful for providing the second substrate 218 (see step 68 in FIG. 6C) which is employed in the preferred manufacturing process of master substrate 208.

The method begins at step 73 and continues to step 74 in which the second substrate 218, which, as stated is preferably made of a hard material, is provided (see FIG. 7A). The method continues to step 75 in which a layer 220 of a photoresist material is applied on substrate 218 (see FIG. 7B).

A photoresist material is a material whose intermolecular bonds are either strengthened or weakened by exposure to certain type of radiation, such as electromagnetic radiation or particle (e.g., electron) beam.

The photoresist material can be applied using any known procedure, such as, but not limited to, coating, printing and lamination. Representative examples of coating procedures include, without limitation, dip coating, roller coating, spray coating, reverse roll coating, spinning or brushing. Representative examples of printing procedures include, without limitation curtain printing or screen printing. The photoresist material used in accordance with the present embodiments may be any material used as a photoresist in the manufacture of diffraction gratings.

The photoresist material can be an organic or an inorganic photoresist material in a liquid or dry form. The photoresist material can be a positive photoresist material or a negative photoresist material. A positive photoresist material is a material that becomes, as a result of the exposure step that follows, non-resistant to the subsequent development step as described hereinbelow. Conversely, a negative photoresist material is a material that becomes, as a result of the exposure step that follows, resistant to the development step that follows.

The method continues to step 76 in which a pattern 222 is recorded on layer 220 (see FIG. 7C). The pattern can correspond to the shape of the linear grating or an inverted shape thereof, depending whether the photoresist material is a negative photoresist material or a positive photoresist material. Since it is desired to form an inverted shape of the grating on the surface of substrate 218, when a positive photoresist is used, the standing wave pattern corresponds to the shape of the linear grating, and when a negative photoresist is used, the pattern corresponds to the inverted shape of the grating.

The pattern can be recorded by means of optical interference, e.g., by forming a standing wave interference pattern of two plane optical waves on layer 220. Alternatively, the pattern can be recorded by means of a scanning electron beam.

Representative examples of photoresist materials suitable for electromagnetic radiation include, without limitation, Microposit SI 805, commercially available from Shipley Corporation, USA. For such photoresist, the preferred recording is by electromagnetic radiation at a wavelength of 365 nm. Representative examples of photoresist materials suitable for electron beam include, without limitation, polymethyl methacrylate or derivatives thereof.

The method continues to step 77 in which the photoresist is developed thereby forming a mask pattern 224 of developed photoresist on the surface of substrate 218 (see FIG. 7D). The method proceeds to step 78 in which substrate 218 is etched, to form ridges and grooves according to the inverted shape 202 of the grating (see FIG. 7E).

The etching process can be any wet or dry etching process known in the art. The wet etching process can include isotropic etchants or anisotropic etchants. The dry etching process can be purely chemical, purely physical or a combination of chemical and physical etching. Suitable dry etching process thus includes, without limitation, chemical dry etching, ion beam etching, reactive ion etching (also known as chemical-physical etching) and laser induced etching.

Once the inverted shape 202 of the grating is formed, the method optionally and preferably continues to step 79 in which mask pattern 224 is removed (see FIG. 7F).

The method for forming substrate 218 ends at step 80.

It is expected that during the life of this patent many relevant light transmissive materials will be developed and the scope of the term light transmissive material is intended to include all such new light transmissive materials a priori.

Additional objects, advantages and novel features of the present invention will become apparent to one ordinarily skilled in the art upon examination of the following examples, which are not intended to be limiting. Additionally, each of the various embodiments and aspects of the present invention as delineated hereinabove and as claimed in the claims section below finds experimental support in the following examples.

### EXAMPLES

Reference is now made to the following examples, which together with the above descriptions illustrate the invention in a non limiting fashion.

### Example 1

### A Detailed Manufacturing Process

FIGS. 7A-L illustrate an exemplified embodiment for manufacturing the optical relay device according to the teachings of the present invention.

FIG. 7A schematically illustrates second substrate 218, which is preferably used for manufacturing the master substrate as further detailed hereinabove.

FIG. 7B schematically illustrates second substrate 218, once layer 220 of photoresist material is applied thereon.

FIG. 7C schematically illustrates second substrate 218, once pattern 222 is recorded on layer 220 FIG. 7D schematically illustrates second substrate 218, once the photoresist is developed to form mask pattern 224 on layer the surface of substrate 218.

FIG. 7E schematically illustrates substrate 218 following the etching process which forms the inverted shape 202 of the grating on substrate 218.

FIG. 7F schematically illustrates substrate 218 following once mask pattern 224 is removed.

FIG. 7G schematically illustrates first substrate 214, which is also used for manufacturing the master substrate as further detailed hereinabove. Substrate 214 is coated by one or more layers 216 of a curable modeling material.

FIG. 7H schematically illustrates the contact between first substrate 214 and second substrate 218. As shown, the modeling material receives the shape of the gratings.

FIG. 7I illustrate master substrate 208, which is formed after the separation of first substrate 214 from second substrate 218.

FIG. 7J illustrate master substrate 208 once one or more metallic layers 212 are applied thereon. The metallic layers serve as a surface of the mold as further detailed hereinabove.

FIG. 7K schematically illustrates mold 200 with a first surface 204 and a second surface 206. First surface is formed by separating metallic layer 212 from master substrate 208. In the present example, second surface 206 is flat, but, as stated, it can be manufactured similarly to surface 204 to include inverted shape of one or more gratings.

FIG. 7L schematically illustrates substrate 14 and grating 13 formed using mold 200.

### Example 2

### Birefringence Tests

Measurements of optical birefringence were made to samples of polycarbonate (PC) and cycloolefin polymer (COP). The measurements were made by the PROmeteus MT-200 inspection system purchased from Dr. Schenk GmbH, Germany. The measurements included the difference Δn between the ordinary index of refraction, nₒ and the extra-ordinary index of refraction nₑ, Δn=nₒ−nₑ.

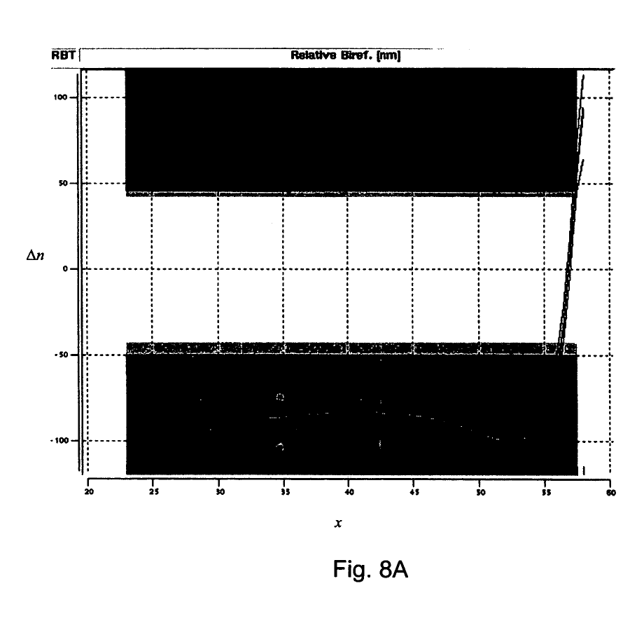

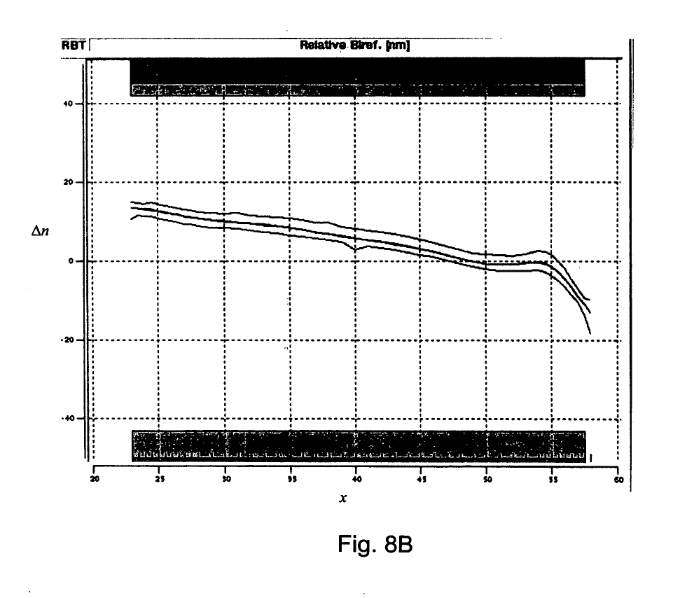

FIGS. 8A-B show Δn as a function of the position x (in millimeters) across a material sample, for the polycarbonate sample (FIG. 8A) and the cycloolefin polymer (FIG. 8B).

The PC measurement revealed birefringence of about −100 nm, in the units of measurement of the measuring system, which correspond to a dimensionless birefringence Δn of about 0.001.

The COP birefringence measurement was less than 15 nm, in the units of measurement of the measuring system, which correspond to a dimensionless birefringence Δn which is no more than 0.00015 (Δn≦0.00015). It is therefore demonstrated that the birefringence of cycloolefin polymer is about an order of magnitude lower in absolute value than the birefringence of polycarbonate.

The low value of birefringence in absolute value of the cycloolefin polymer significantly reduces the rotation of the polarization of the light during the propagation of light within the substrate. Thus, a linearly polarized light entering the substrate such that the polarization direction is parallel to the direction of the grating grooves, substantially maintains the polarization during the propagation. As a result, high diffraction efficiency is achieved also at the output grating.

### Example 3

### Monochromatic Binocular Configuration for Blue Light

This example demonstrate the attainable field-of-view when the optical relay device is used for binocular view, in the embodiment in which there is one input linear grating and two output linear gratings. The following demonstration is for a substrate made of cycloolefin polymer having a refraction index of n_{S}=1.531.

Equation 1 is employed for a wavelength λ=465 nm (blue light), and indices of refraction n_{S}=1.531 for the substrate and n_{A}=1.0 for air, corresponding to a critical angle of 40.78°.

For a grating period d=430 nm (λ/d>1, see Equation 5), Equation 2 provides the maximal (negative by sign) angle at which total internal reflection can be occur is 4.67°. In the notation of FIG. 3A, α_{I}⁺⁻=−4.67° (see ray 53). The positive incidence angle (see ray 51 of FIG. 3A), on the other hand, can be as large as α_{I}⁻⁻=25.24°, in which case the diffraction angle is about 80°, which comply with the total internal reflection condition. Thus, in this configuration, each of the attainable asymmetric field-of-views is of |α_{I}⁺⁺|+α_{I}⁻⁻≈30°, resulting in a symmetric combined field-of-view of 2×α_{I}⁻⁻≈50°.

### Example 4

### Monochromatic Binocular Configuration for Red Light

This example demonstrate the attainable field-of-view when Equations 1, 2 and 6 are employed for a wavelength λ=620 nm (red light) and the refraction indices of Example 3, corresponding to the same critical angle (α_{c}=40.78°).

Imposing the “flat” requirement and a maximal diffraction angle of 80°, one can calculate that for λ=620 nm the grating period of Example 3 d=430 nm complies with Equation 6.

The maximal (positive by sign) incidence angle at which total internal reflection can occur is 3.78°. In the notation of FIG. 3B, α_{I}⁻⁺=+3.78° (see ray 52). The negative incidence angle (see ray 54 of FIG. 3B) is limited by the requirement |α_{D}⁺⁺|<α_{c}, which corresponds to α_{I}⁺⁺=−26.22°. Thus, in this configuration, each of the attainable asymmetric field-of-views is of about 30°, resulting in a symmetric combined field-of-view of about 52°.

### Example 5

### Multicolor Binocular Configuration

This example demonstrate the attainable field-of-view when Equations 1, 2 and 8 are employed for a spectrum in which the shortest wavelength is λ_{B}=465 nm (blue light) and the longest wavelength is λ_{R}=620 nm (red light). The refraction indices, the critical angle and the maximal diffraction angle are the same as in Example 4.

Using Equation 8, one obtains d=433 nm. Further, using Equation 2 one can calculate the asymmetric field-of-views of the blue and red lights.

Hence for the blue light the first asymmetric field-of-view is [−4.24°, 25.71°], the second asymmetric field-of-view is [−25.71°, −4.24°], resulting in a combined field-of-view of about 51°.

For the red light, the calculation yield an opposite situation in which the first asymmetric field-of-view is [−25.59°, 4.35°], and the second asymmetric field-of-view is [−4.35°, 25.59°], still resulting in a combined field-of-view of about 51°.

If a third, intermediate wavelength is present, say 525 nm (green light), then the first green asymmetric field-of-view is [−12.27°, 17.17°], and the second green asymmetric field-of-view is [−17.17°, 12.27°], resulting in a symmetric combined field-of-view of about 34°. Thus, the overlap between the individual wavelength-dependent field-of-views is of 34°. It will be appreciated that selecting a different period for the gratings may result in a larger overlapping field of view.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. An optical relay device, comprising:
a substrate, made at least in part of a light transmissive polymeric material characterized by a birefringence, Δn, satisfying the inequality |Δn|<ε, wherein ε is lower than the birefringence of polycarbonate; and
at least one diffractive optical element located on at least one surface of said substrate.

2. The device of claim 1, wherein said at least one diffractive optical element is formed on said at least one surface.

3. The device of claim 1, wherein said at least one diffractive optical element is attached to said at least one surface.

4. The device of claim 1, wherein said polymeric material comprises a cycloolefin polymer.

5. The device of claim 1, wherein said polymeric material comprises a polycyclic polymer.

6. The device of claim 1, wherein said light transmissive polymeric material comprises a copolymer.

7. The device of claim 6, wherein said copolymer comprises a cycloolefin copolymer.

8. The device of claim 6, wherein said copolymer comprises a polycyclic copolymer.

9. The device of claim 1, wherein said at least one diffractive optical element comprises an input diffractive optical element and at least one output diffractive optical element.

10. The device of claim 1, wherein said at least one diffractive optical element comprises linear grating.

11. The device of claim 1, wherein said at least one diffractive optical element comprises an input diffractive optical element, a first output diffractive optical element and a second output diffractive optical element.

12. The device of claim 11, wherein said input diffractive optical element is designed and constructed for diffracting light striking the device at a plurality of angles within a predetermined field-of-view into said substrate, such that light corresponding to a first partial field-of-view propagates via total internal reflection to impinge on said first output diffractive optical element, and light corresponding to a second partial field-of-view propagates via total internal reflection to impinge on said second output diffractive optical element, said first partial field-of-view being different from said second partial field-of-view.

13. A system for providing an image to a user, comprising an optical relay device for transmitting an image into at least one eye of the user, and an image generating system for providing said optical relay device with collimated light constituting said image,
said optical relay device comprising:
a substrate, made at least in part of a light transmissive polymeric material characterized by a birefringence, Δn, satisfying the inequality |Δn|<ε, wherein ε is lower than the birefringence of polycarbonate, and
a plurality of diffractive optical elements located on at least one surface of said substrate.

14. The system of claim 13, wherein said plurality of diffractive optical elements is formed on said at least one surface.

15. The system of claim 13, wherein said plurality of diffractive optical elements is attached to said at least one surface.

16. The system of claim 13, wherein said plurality of diffractive optical elements comprises an input diffractive optical element, a first output diffractive optical element and a second output diffractive optical element.

17. The system of claim 16, wherein said input diffractive optical element is designed and constructed for diffracting light originated from the image into said substrate such that a first partial field-of-view of the image propagates via total internal reflection to impinge on said first output diffractive optical element, and a second partial field-of-view of the image propagates via total internal reflection to impinge on said second output diffractive optical element, said first partial field-of-view being different from said second partial field-of-view.

18. The system of claim 17, wherein said image generating system comprises a light source, at least one image carrier and a collimator for collimating light produced by said light source and reflected or transmitted through said at least one image carrier.

19. The system of claim 17, wherein said image generating system comprises at least one miniature display and a collimator for collimating light produced by said at least one miniature display.

20. The system of claim 17, wherein said image generating system comprises a light source, configured to produce light modulated imagery data, and a scanning device for scanning said light modulated imagery data onto said input diffractive optical element.

21. A method of manufacturing an optical relay device having at least one linear grating, comprising:
forming a mold having at least one pattern corresponding to an inverted shape of the at least one linear grating; and
contacting said mold with a light transmissive polymeric material characterized by a birefringence, Δn, satisfying the inequality |Δn|<ε, wherein ε is lower than the birefringence of polycarbonate, so as to provide a substrate having the at least one linear grating formed on at least one surface thereof.

22. The method of claim 21, wherein said polymeric material comprises a cycloolefin polymer.

23. The method of claim 21, wherein said polymeric material comprises a polycyclic polymer.

24. The method of claim 21, wherein said light transmissive polymeric material comprises a copolymer.

25. The method of claim 24, wherein said copolymer comprises a cycloolefin copolymer.

26. The method of claim 24, wherein said copolymer comprises a polycyclic copolymer.

27. The method of claim 21, wherein said contacting is by injection molding.

28. The method of claim 21, wherein said light transmissive polymeric material is in a solid form.

29. The method of claim 28, wherein said light transmissive polymeric material is in form of a substrate having optically flat surfaces.

30. The method of claim 29, further comprising coating at least one of said optically flat surfaces by a curable modeling material, prior to said contacting of said mold with said light transmissive polymeric material.

31. The method of claim 30, wherein said contacting comprises pressing said mold against said light transmissive polymeric material in said solid form.

32. The method of claim 30, wherein said curable modeling material comprises at least one photopolymer component.

33. The method of claim 30, wherein said curable modeling material comprises at least one curable component.

34. The method of claim 30, wherein said curable modeling material comprises a thermally settable material.

35. The method of claim 21, wherein at least one surface of said mold is formed by coating a master substrate having the at least one linear grating formed thereon by a metallic layer, and separating said metallic layer from said master substrate, thereby forming said at least one surface.

36. The method of claim 35, wherein said mold comprises a second surface which is substantially flat.

37. The method of claim 35, wherein said coating said master substrate by said metallic layer comprises sputtering followed by electroplating.

38. The method of claim 35, further comprising forming said master substrate.

39. The method of claim 38, wherein said forming said master substrate comprises:
providing a first substrate coated by a layer of curable modeling material;
contacting said first substrate with a second substrate having said inverted shape of the at least one linear grating formed thereon;
curing said curable modeling material, thereby providing a cured layer patterned according to the shape of the at least one linear grating; and
separating said first substrate from said second substrate to expose said cured layer on said first substrate, thereby forming said master substrate.

40. The method of claim 39, wherein said curable modeling material comprises at least one photopolymer component, and said step of curing said curable modeling material comprises irradiating said curable modeling material by electromagnetic radiation.

41. The method of claim 39, wherein said curable modeling material comprises at least one curable component, and said step of curing said curable modeling material comprises irradiating said curable modeling material by curing radiation.

42. The method of claim 39, wherein said curable modeling material comprises a thermally settable material, and said step of curing said curable modeling material comprises applying heat to said thermally settable material.

43. The method of claim 39, further comprising, prior to said step of contacting said first substrate with said second substrate, forming said inverted shape of the at least one linear grating on said second substrate.

44. The method of claim 43, wherein said forming said inverted shape of the at least one linear grating on said second substrate is by a ruling engine.

45. The method of claim 43, wherein said forming said inverted shape of the at least one linear grating on said second substrate is by lithography followed by etching.

46. The method of claim 45, wherein said lithography comprises photolithography.

47. The method of claim 45, wherein said lithography comprises electron beam lithography.
